(19) United States
(12) Patent Application Publication
(10) Pub. No.: US 2019/0172165 A1
(43) Pub. Date: Jun. 6, 2019

(54) BUILDING-RESOURCE MANAGEMENT SYSTEM

(71) Applicant: Spaceti LG Ltd., London (GB)

(72) Inventors: Maksym Verteletskyi, Prague (CZ); Maksym Huk, Prague (CZ); Aakash Ravi, Stamford, CT (US); Ondrej Plevka, Prague (CZ); Tomá{hacek over (s)} Barták, Chrudim (CZ); Dan {hacek over (S)}uster, ?eske Budejovice (CZ); Mario Kamburov, Prague (CZ); Petr {hacek over (S)}t{hacek over (e)}tina, StranCice (CZ)

(21) Appl. No.: 16/211,118

(22) Filed: Dec. 5, 2018

(30) Foreign Application Priority Data
Dec. 6, 2017 (GB) 1720331.6

(51) Int. Cl. G06Q 50/16; G06Q 30/02; G06Q 10/02; G01C 21/20

(52) U.S. Cl. CPC G06Q 50/163; G06Q 30/0284; G01C 21/206; G06Q 30/0206; G06Q 10/02

(57) ABSTRACT

Systems and methods for managing resources of a building are described herein. The system determines real-time locations of one or more user devices that correspond to persons within the building. When one of the user devices generates a reservation request to reserve an occupant space in the building, the system determines a space that matches the requests and assigns the space to the requesting user. Once the occupant space is assigned to the user, the system can further calculate personal routes that guide the user to and/or from the assigned space.

### CROSS-REFERENCE TO RELATED APPLICATION(S)

This application claims the benefit of and priority to U. K. Patent Application No. 1720331.6, titled “SYSTEMS INTEGRATOR, BUILDING MANAGEMENT, CONTROL AND MONITORING SYSTEM” and filed Dec. 6, 2017, which is incorporated herein by reference in its entirety.

This application contains subject matter related to a concurrently-filed PCT Patent Application by Maksym Verteletskyi, Maksym Huk, Aakash Ravi, Ondrěj Plevka, Tomáš Barták, Dan Šuster, Mario Kamburov, and Petr Štětina titled “ZONE-BASED BUILDING CONTROL AND MONITORING SYSTEM,” which is assigned to Spaceti LG Ltd., is identified by attorney docket number 129532-8001.WO00, and is incorporated herein by reference in its entirety.

This application contains subject matter related to a concurrently-filed PCT Patent Application by Maksym Verteletskyi, Maksym Huk, Aakash Ravi, Ondrěj Plevka, Tomáš Barták, Dan Šuster, Mario Kamburov, and Petr Štětina titled “BUILDING-RESOURCE MANAGEMENT SYSTEM,” which is assigned to Spaceti LG Ltd., is identified by attorney docket number 129532-8002.WO00, and is incorporated herein by reference in its entirety.

### TECHNICAL FIELD

The present invention relates to systems for monitoring and managing various resources available in buildings, and in particular, but not exclusively, a building-resource management system for managing access of resources available in a building for its occupants.

### BACKGROUND

In modern settings, buildings include several unconnected and/or stand-alone systems which control different aspects of the building. For example, most buildings have one or more elevators that are operationally controlled by elevator control systems and environmentally controlled by heating-ventilation and air-conditioning (HVAC) systems. Also, some buildings may have energy management systems that control electricity and gas usage, emergency systems that provide back-up power or facilitate emergency scenarios, security systems for monitoring and/or controlling access to different parts of the building, etc. Some large buildings, such as larger office buildings or public use buildings, tend to be fitted with computer-aided facility management (CAFM) systems or building management systems.

However, these various task-based systems traditionally focus on individual tasks without interacting with other systems. For example, the elevator systems typically operate to achieve their preprogrammed goals without regard to the needs or targets of other systems, such as the energy management systems and/or the security systems. Further, many systems typically include devices that are integral or built-in to the building, which can make it difficult to update system capabilities.

While some building management systems (BMSs) seek to solve these problem, not all pre-existing systems are able to provide the data and/or levels of control necessary to implement the BMS. Moreover, the BMSs typically require user input or programming updates to account for system layouts (e.g., an HVAC configuration), building layouts (e.g., a floor plan), etc. As such, each change in the various systems and/or the layouts may require a system update and/or a software update. Moreover, BMSs typically do not interact with building occupants, and thus cannot directly respond to the needs or requests of the occupants. It would therefore be beneficial to provide a simplified interface between environmental control subsystems and dynamically adjust the various parameters or settings of the subsystem(s) to meet the real-time needs and demands of the building occupants.

### BRIEF DESCRIPTION OF THE DRAWINGS

FIG. 1 is a schematic diagram of an example environment in which a building-resource management system may operate according to some embodiments.

FIG. 2 is a block diagram of a building-resource management system configured in accordance with some embodiments.

FIG. 3A is a block diagram of a linking device configured in accordance with some embodiments, and FIG. 3B is a flow diagram illustrating an example process for operating the linking device of FIG. 3A according to some embodiments.

FIG. 4 illustrates an example display of a user device configured in accordance with some embodiments.

FIG. 5A is a flow diagram illustrating an example process for implementing a building-resource management system according to some embodiments, and FIG. 5B is a flow diagram illustrating a further example process for implementing a building-resource management system according to some embodiments.

FIG. 6 is a block diagram of an example computing device in accordance with various embodiments.

### DETAILED DESCRIPTION

Systems and methods for managing resources available in buildings are described herein. A building-resource management system configured in accordance with some embodiments allows full or semi-automatic/autonomous management and/or assignment of resources, such as occupancy spaces (e.g., cubicle or office space, conference rooms, etc.), devices (e.g., projectors, whiteboards, etc.), or other facilities, available in a building. The building-resource management system can include a control module (e.g., a circuit, such as a processor and a memory including a set of instructions) configured to interface with one or more subsystems of the building, a set of sensors in the building, personal or mobile devices belonging to and/or carried by building occupants, and/or other internal or external systems. The control module can gather various information from the interfacing systems or devices, and according to the gathered information, control one or more of the devices or subsystems associated with the building. The control module can further interact with the individual occupants through their mobile devices (e.g., smart phones, wearable devices, etc.). In some embodiments, the control module can track and manage usage of building resources, changes to resource settings, and/or scheduling of the building resources for individual occupants of the building.

In some embodiments, the building-resource management system can include a linking device configured to interface with occupant devices and/or existing subsystems in a building. For example, the linking device can include, be integral with, and/or be connected to wired or wireless access nodes (e.g., wireless routers, network connectors, etc.) that communicate with the occupant devices (e.g., smart phones, wearable devise, access keys, etc.). The linking device can be configured to route building-related communications between the occupant devices and the control module. Also, the linking device can include circuitry, connections, instructions, etc. configured to interact with a designated building subsystem (e.g., elevator systems, HVAC systems, access/security systems, lighting systems, etc.) including pre-existing and/or older systems that were initially configured to operate as a standalone system/device. Accordingly, the linking device provides the building-resource management system increased flexibility in retrofitting buildings having existing standalone systems. Traditional BMSs and CAFM systems often require direct connection to all managed systems, and as such, installation of such systems can require extensive reconstruction/rewiring for the entire building. In contrast, by using a linking device for each subsystem and connecting the linking devices to the control module through a network connection, retrofitting activities and building upgrades can be modularized to overall reduce and further allow flexibility in scaling and controlling building construction activities.

In some embodiments, the building-resource management system can manage the resources (e.g., specific rooms, allocated energy allowance, building-owned devices, etc.) in the building for each of the occupants. For example, the building-resource management system can interact with the occupants to schedule/reserve the resources, track their usage with or without the scheduling, recommend specific resources (e.g., nearest room or device that fits the occupant requirements) and/or identify locations thereof, etc. Also, the building-resource management system can provide an individualized indoor routing function based on tracking an occupant location relative to building resources.

Based on the individualized routing, the building-resource management system can provide an improved user-experience and increased safety for the occupant. For example, the building-resource management system can determine dangerous locations (e.g., a location of a fire or other structural/device failures) and divert occupants away during emergency situations. Further, the building-resource management system can determine individual optimal routes to control a crowd of people, thereby improving evacuation flow through access ways without overcrowding them.

### Suitable Environments

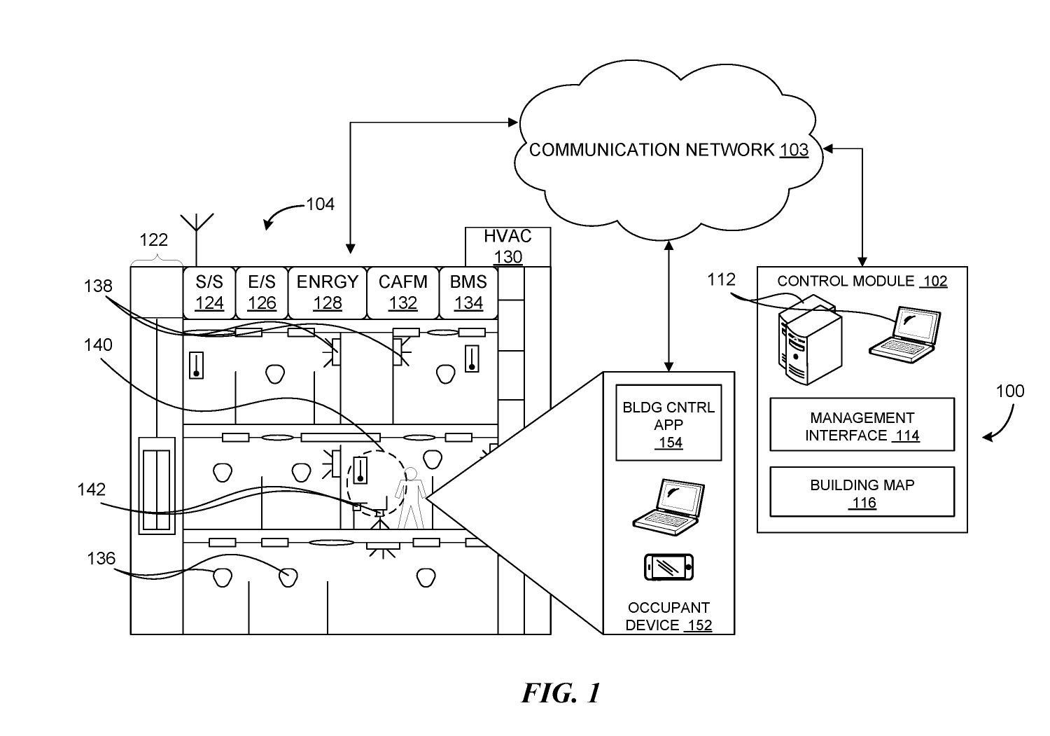

FIG. 1 and the following discussion provide a brief, general description of an example suitable environment in which a building-resource management system 100 may be implemented. Although not required, aspects of the invention are described in the general context of computer-executable instructions, such as routines executed by a general-purpose computer, a personal computer, a server, and/or other computing system. The invention can also be embodied in a special purpose computer or data processor that is specifically programmed, configured, and/or constructed to perform one or more of the computer-executable instructions described in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random-access memory (RAM), read-only memory (ROM), flash memory, or the like, or a combination of such components. Computer-executable instructions may also be stored in one or more storage devices such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the invention can also be practiced in distributed computing environments (e.g., public, private, or hybrid clouds), where tasks or modules are performed by remote processing devices linked through a communications network including, but not limited to, a Local Area Network (LAN), Wide Area Network (WAN), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, or stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer while corresponding portions reside on a client computer.

Referring to the embodiment of FIG. 1, the building-resource management system 100 in which aspects of the described technology may operate includes a control module 102 operably configured to interact with and/or manage one or more devices/systems in a building 104. The control module 102 can include circuitry (e.g., a processor connected to a memory including instructions) configured to track and manage various aspects/resources of the building 104 and interact with individual occupants, all in real-time or substantially in real-time. The control module 102 can be implemented using one or more system managing devices 112, such as a server, a general-purpose or specialized computer, or other computing device. The control module 102 can also include a system management interface 114 (e.g., a building management application, a graphic user interface (GUI), and/or other user interfacing mechanism) configured to allow building owners or administrative users to access and interact with the building-resource management system 100. For example, the system management interface 114 can enable the building owners via the control module 102 (e.g., the system managing devices 112) to access and/or adjust targeted ambient settings (e.g., of the HVAC system, the lighting system, etc.), adjust desired resource consumption or usage rate (e.g., via electrical panel), determine one or more costs associated with occupancy or usage of building resources, view current settings or status of systems/devices, etc. Also, facility users can receive, even at remote locations, real-time status of one or more devices/systems in the building, such as for troubleshooting or repair purposes. Further, managing users or owners can view or track costs, payments, etc. of occupants for billing or analytic purposes.

In some embodiments, the control module 102 can include or access one or more maps (e.g., a building map 116) of the building 104. The building map 116 can describe spaces within the building 104, and/or physical characteristics associated with the spaces. For example, the building map 116 can include locations of barriers (e.g., walls, doors, dividers columns, etc.), such as for rooms, offices, and/or cubicles. The building map 116 can also include zones or spaces that are affected by one or more environmental control components (e.g., a fan, a vent, a light fixture, etc.) in the building 104. The building map 116 can further include one or more graphs of routes inside the building 104, locations of emergency exits, exit routes, or a combination thereof. In some embodiments, the control module 102 can be configured to autonomously generate and/or update the building map 116. Details regarding the generation/update of the building map 116 are described below.

The control module 102 can be connected to one or more devices/systems in the building 104, such as to an elevator system 122, a security system 124 (e.g., an access/gate control system, a closed-circuit television (CCTV) system, etc.), an emergency system 126, an energy management system 128, an HVAC system 130, and/or other purpose-specific device/system. In some embodiments, the control module 102 can be connected to one or more smart or comprehensive systems, such as a computer-aided facility management (CAFM) system 132 that allows users (e.g., staff users) to manage spaces within the building 104, a BMS 134, etc. While some BMSs may be configured to sense (e.g., via a network of sensors) and control environmental conditions in the building 104, the operations can be enhanced by the control module 102 via zone-specific monitoring and control of one or more conditions in the building. Further, the control module 102 can be configured to provide additional features not included in the BMS 134, such as: smart/autonomous mapping and associated control adjustments, interacting with and providing controls to individual occupants, providing turn-by-turn indoor navigation for individual occupants, scheduling and managing building resources (e.g., rooms, devices, etc.), etc.

In some embodiments, the control module 102 (e.g., implemented using one or more of the system managing devices 112) can be located at or near the building 104, at a remote location away from the building, and/or in a distributed computing environment. Further, in some embodiments, the control module 102 (e.g. one or more of the system managing devices 112) can be integral with the BMS 134, such as via separate software applications running on the same device or by including the BMS 134 as a component connected to the control module 102.

In some embodiments, the building-resource management system 100 can include or utilize a plurality of linking devices 136. The linking devices 136 include circuits configured to facilitate data collection, interface with the building occupants, and/or interface with the devices/subsystems of the building. For example, as described in greater detail below, the linking devices 136 can include environmental and/or status sensors, such as: a temperature sensor, a humidity sensor, a carbon monoxide/dioxide sensor, other gas/organic compound sensors, a particulate matter sensor/detector, an ozone or radon sensor/detector, a noise detector or microphone, a light sensor, an occupant presence sensor (e.g., passive infrared (PIR) presence sensors), a capacity sensor for sensing a load, a mmWave radar for distance measurements, a magnetic field sensor/detector, a barometric sensor, a hydrogen sensor, an ethanol sensor, a camera for imaging the surrounding environment, an accelerometer for detecting the sensor's movements, a gyroscope for detecting the sensor's orientation, or a combination thereof. Also, the linking devices 136 can include circuits (e.g., a wireless transmitter, receiver, router/modem, etc.) configured to provide wireless connection to one or more user devices (e.g., smart phones, wearable devices, access keys, etc.) and/or provide an interface between the user devices and the control module 102. Further, the linking devices 136 can include circuits configured to facilitate processes for locating wireless/mobile devices, such as by transmitting beacon signals, measuring or calculating signal strengths/delays/Doppler shift/etc., interpolating or filtering the measurements (e.g., a Kalman filter to interpolate signal strength measurements), calculating distance based on the measured or calculated result, and/or performing multilateration. For example, the control module 102 can include a multilaterator, such as a Levenberg-Marquardt Multilaterator (LMM), a multilateration cycle queue (MCQ), etc. for locating the mobile devices.

In some embodiments, the control module 102 can be connected to communication nodes 138 (e.g., wireless routers, network connectors/ports) located in the building 104. The communication nodes 138 can in turn be connected to one or more devices/systems (e.g., the user devices 152, the building subsystems, etc.) via a communication network 103, such as a wired or wireless network, a telephone network, the Internet, a cellular network, etc. As such, the control module 102 can communicate with the one or more devices/systems in the building 104 via the communication nodes 138. In some embodiments, as described above, the linking devices 136 can include the communication nodes 138 or functionalities thereof.

For some embodiments, the control module 102 can be connected to a set of sensors 140 in the building, such as environmental and/or status sensors or detectors separate from the linking devices 136. Examples of the sensors 140 can include temperature sensors, humidity sensors, carbon monoxide/dioxide sensors, other gas/organic compounds sensors, particulate matter sensors, ozone or radon sensors, noise detectors or microphones, light sensors, presence sensors, capacity sensors, mmWave radars, magnetic field sensors, barometric sensors, ethanol sensors, cameras, accelerometers, gyroscopes, etc. Other examples of the sensors 140 can include self-test or status reporting circuits associated with one or more of the building subsystems. In some embodiments, the sensors 140 can include presence sensors 142 configured to detect the presence of one or more persons in a corresponding location or space. Some examples of the presence sensors 142 can include weight or pressure sensors located in or on the building floor, furniture (e.g., chairs and/or desks), etc.

As mentioned above, in some embodiments, the control module 102 can interface with individual occupants of the building 104. For example, the control module 102 can communicate with user devices 152 (e.g., smartphones, wearable devices, laptops, etc.) belonging to or operated by the occupants. The user devices 152 can include or access building control application 154 (e.g., software applications, GUI, etc.) configured to enable the occupants to interact with the control module 102 via their devices. For example, the user devices 152 can include a screen that displays available resources (e.g., office spaces, conference rooms, rental devices or furniture, etc.) or locations thereof, indoor routes to destinations, resource or user billing information, current environment settings, and/or other information associated with the building 104. Also, the user devices 152 can receive desired environmental settings (e.g., desired temperature and/or air flow), requests for resources, or requests for other information associated with the building 104 from the building occupants and communicate them to the control module 102.

In some embodiments, the control module 102 can include or interact with a monitoring network that includes the linking devices 136, the communication nodes 138, the sensors 140 (including the presence sensors 142), the user devices 152 (e.g., via the building control application 154), or a combination thereof. The monitoring network can implement various features, such as for: tracking individual occupants, tracking usage/occupancy/availability of resources, tracking the status/state of various aspects of the environment inside the building 104 or its subsystems, etc. One or more components of the monitoring network and/or the communication network 103 can communicate using ultra-high frequency signals (e.g., a frequency range including or about 2.4 GHz), sub-gigahertz signals (e.g., a frequency range including 850 MHz to 950 MHz), etc. For example, the monitoring network and/or the communication network can communicate wireless signals according to one or more protocols, such as for wireless LAN (e.g., WiFi), cellular communications (e.g., one or more of 2G-5G cellular standards), Internet of Things (IoT) communication mechanism (e.g., NB-IoT, LTE-M, etc.), peer-to-peer or device-to-device communication protocols (e.g., Bluetooth, Near-Field communication (NFC), etc.), and/or other wireless communication mechanisms.

### System Components

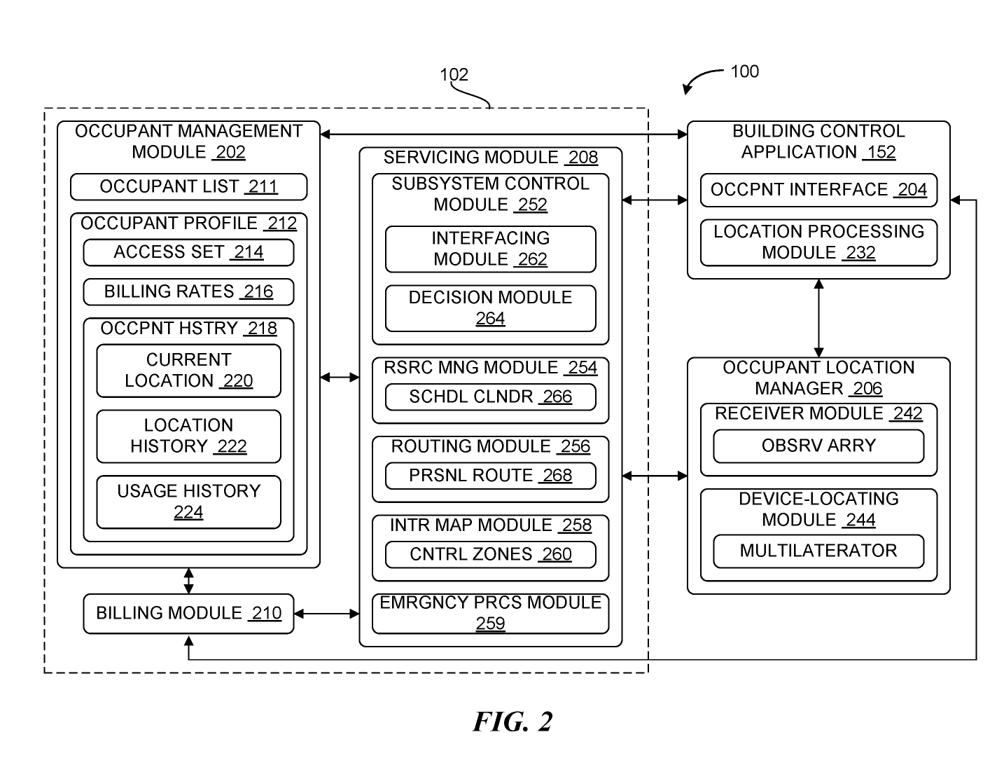

FIG. 2 is a block diagram illustrating various components (e.g., software components, modules, and/or circuits) of a building-resource management system (e.g., the building-resource management system 100) configured in accordance with some embodiments. In some embodiments, the building-resource management system 100 can include an occupant management module 202, a building control application 154, an occupant location manager 206, a servicing module 208, and a billing module 210. The components of the building-resource management system 100 can be operatively connected to each other, such as through function calls, communication protocols, etc.

One or more of the components of the building control and monitoring system 100 can be included in or executed by the control module 102 and/or one or more interfaces or APIs implemented on the user devices. For example, one or more of the components can be stored in memory components, executed by one or more processors, and/or implemented by specialized circuits on the system managing devices 112, the user devices 152, the linking devices 136, and/or other devices in the communication network and/or the monitoring network as illustrated on FIG. 1. In some embodiments, the control module 102 can include the occupant management module 202, the servicing module 208, the billing module 210, the occupant location manager 206, a portion thereof, or a combination thereof. The control module 102 can be implemented via one or more of the system managing devices 112. In some embodiments, portions of the control module 102 can be implemented using the building control application 154, the linking devices 136, or a combination thereof. In some embodiments, the user devices 152, the system managing devices 112, and/or the linking devices 136 can implement the occupant location manager 206 or portions thereof.

The occupant management module 202 can be configured to oversee information associated with authorized occupants of the building 104 of FIG. 1. For example, the occupant management module 202 (e.g., one or more databases and/or associated circuits) can maintain an allowed occupant list 211. In some embodiments, the allowed occupant list 211 can correspond to organizations and/or individuals that have a contractual agreement to lease or utilize space(s) in the building 104. The allowed occupant list 211 can further correspond to a member or an employee list for the organization occupying a space within the building 104. Also, the occupant management module 202 can maintain an occupant profile 212 that corresponds to each of the occupants on the allowed occupant list 211. The occupant profile 212 can include various data associated with the corresponding occupant usage and/or access to the building 104, such as an access set 214, one or more billing rates 216, and/or occupant history 218.

In some embodiments, the occupant profile 212 can include the access set 214 that describes a permission given to the corresponding occupant for accessing and/or controlling one or more features, conditions, or resources associated with the building 104. For example, the building occupants may have different levels of control regarding services, access to resources, and/or environmental conditions in the building 104. The occupants with administrative or higher-level access may have settings in the occupant profile 212 that allows them to adjust environmental conditions, such as lighting and/or temperature settings. Also, occupants with lower-level access (e.g., non-administrative members/employees of the leasing organization) may have settings in the occupant profile 212 that allows them to access a set of spaces (e.g., elevators, bathrooms, other spaces within a larger boundary assigned to the occupant organizations, etc.), and/or have limited control over the environmental conditions at their designated/assigned spaces, etc. Also, visitors (e.g., devices or user identifications not included in the allowed occupant list 211) may be given default or limited settings in the occupant profile 212 that control such user access to the building 104. In some embodiments, a visitor may be given limited access to designated spaces, such as lobby areas, a specific floor while using the elevator, a specific conference room, designated bathroom, etc.

In some embodiments, the occupant profile 212 can include the billing rates 216 applicable to the corresponding occupant. The billing rates 216 can include one or more cost parameters (e.g., a financial amount, a usage credit, etc.) associated with the corresponding occupant stay in the building and/or usage of one or more resources thereof. For example, the billing rates 216 can include the occupant utility price, an assigned price associated with adjustments to the environmental conditions, an assigned price for using one or more resources (e.g., a projector, a conference room, a copier, etc.), etc. associated with the building 104. The billing rates 216 can include a mechanism (e.g., a formula, a process, and/or a routine) that dynamically adjusts the prices substantially in real-time according to various factors, such as active or real-time demand, external conditions (e.g., a convention or event drawing increased number of visitors or other market conditions), usage or occupancy projection, or a combination thereof.

In some embodiments, the occupant profile 212 can track the occupant history 218. The occupant history 218 can include a record of the corresponding occupant locations within the building 104 and/or usage of one or more resources in the building 104. For example, the building-resource management system 100 can determine a current location 220 of the corresponding occupant within the building 104. The control module 102 (e.g., the occupant management module 202) can track a location history 222 for the corresponding occupant by storing the current location 220 of the occupant with a time stamp. Also, the control module 102 can track a resource usage history 224 that keeps a record of an occupant usage or consumption of one or more facilities (e.g., gym, bathroom, etc.), utilities (e.g., water, electricity, etc.), services (e.g., concierge services or laundry/dry-cleaning services), and/or resources (e.g., occupant spaces or rental devices) at the building 104. The control module can track the resource usage history 224 based on occupant access events (e.g., sign-on and/or sign-off, scheduling or reservation, presence in reserved location at the reserved time, and/or other occupant authentication associated with access) associated with the building resources. In some embodiments, the occupant location/usage information can be tracked anonymously (e.g., using system identifiers instead of occupant identification), such as for path calculation and/or emergency purposes. In other embodiments, the occupant location/usage information can be tracked according to the occupant identification, such as for billing purposes.

The building control application 154 can be configured to provide each occupant with an interface to the building-resource management system 100. For example, the building control application 154 can include a user application running on the user device 152 that allows interaction between the control module 102, the building subsystems, and/or the building occupant. The building control application 154 can include an occupant interface 204 that the occupant can use to access one or more system features or records. In some embodiments, the occupant can use the occupant interface 204 to reserve or request access to one or more resources in the building 104. In some embodiments, the occupant can receive real-time turn-by-turn navigation within the building. The occupant may also use the occupant interface 204 to access billing-related information (e.g., balances, rates, history, targets or goals, etc.).

In some embodiments, the building control application 154 can include a location processing module 232. The location processing module 232 can include features or functions (e.g., instructions to be implemented by the user devices 152) configured to calculate the current location 220 of the corresponding user device, such as by operating the user device 152 to interact with the monitoring network and/or the control module 102 to locate the user device based on processing signals from known locations. For example, the location processing module 232 can cause one or more wireless receivers to identify one or more beacon or reference signals and/or any associated measurements (e.g., signal strength, phase shift, propagation delay, etc.) for signals transmitted by one or more reference devices in the monitoring network. In some embodiments, the location processing module 232 can include instructions for transmitting the signal measurements and/or other measurements (e.g., from an accelerometer, a gyroscope, a compass, etc. of the device) to the control module 102 (e.g., to the occupant location manager 206). In other embodiments, the location processing module 232 can include instructions for calculating (e.g., using a dead-reckoning mechanism and/or a multilateration mechanism) the current location 220 using the corresponding user device, and for reporting the current location 220 to the control module 102 (e.g., to the occupant management module 202). Also, the location processing module 232 can cause the wireless transmitter of the corresponding user device to transmit a beacon or reference signal, such as at a designated time and/or interval, for the purposes of locating the corresponding user device.

The occupant location manager 206 can be configured to calculate the current location 220 for each of the user devices 152 located in the building 104. The occupant location manager 206 can calculate the current locations (e.g., physical locations of occupants) using multilateration and/or dead-reckoning based on the measurements associated with each of the user devices 152 and/or prior knowledge of the building environment (e.g., the building map 116 including floor plans, location of linking devices, communication nodes, and/or sensors, etc.).

As an implementation example, one or more processes executed by a software application (e.g., the control module 102 or portions thereof) can observe a user location. The processes can send a message or set a flag to receive location updates by creating a localization session. The localization session can be represented by a portion of the occupant location manager 206 configured to receive high-level commands and provide asynchronous updates of the current location of one or more occupants. The occupant location manager 206 can communicate with other devices, such as between the linking devices 136 and the user devices 152, using a wireless communication mechanism (e.g., Bluetooth). The occupant location manager 206 can filter out measurement noise and/or combine locations of reference devices (e.g., beacon transmitters or receivers) to produce location approximations.

In some embodiments, the occupant location manager 206 can include a measurement receiver module 242, a device-locating module 244, or a combination thereof. The measurement receiver module 242 can interact with one or more circuits/modules (e.g., motion or measurement reporting circuit/module) of the user devices 152 to acquire location-based information or measurements. For example, the measurement receiver module 242 can include an observation array (e.g., a specifically-configured data structure) configured to manage signal strength measurements (e.g., received signal strength indicator (RSSI) measurements) made at the user devices 152. The measurement receiver module 242 can receive the signal strength measurements associated with the corresponding user device sending/receiving the beacon signals. The measurement receiver module 242 can record the received measurements in the observation array with time stamps.

In some embodiments, the measurement receiver module 242 can update the observation array to track a set of most-recent locations and/or maintain only validated locations. For example, the observation array can include an active measurement set, which can cache measurements across multiple batch updates of asynchronously arriving signal strength measurements. When a new batch of measurements arrives, the observation array can use beacon identification to pair measurements with a known location of the reference device (e.g., beacon transmitter or receiver). The observation array can also discard unpaired measurements. The pairings, along with the measured signal strengths and its time stamps, can be stored in the active measurement set. If the active measurement set includes measurements associated with the same beacons, the measured signal strengths can be updated, and their respective timestamps can be reset or replaced. In some embodiments, signal strength measurements can be removed from the active measurement set when they are not updated for a predetermined duration to prevent older measurements from influencing newer measurements. The observation array can notify other components whenever the active measurement set is adjusted.

In some embodiments, the measurement receiver module 242 can process the received information using one or more filters (e.g., filters corresponding to linear models, such as Kalman filters). For example, the measurement receiver module 242 can use the one or more filters to interpolate the RSSI measurements with a damping constant to suppress rapid fluctuations in sequentially measured values. Based on the one or more filters, the measurement receiver module 242 can apply different damping constants based on an accelerometer reading of the user device. In some embodiments, the measurement receiver module 242 can apply a first damping constant when the accelerometer output indicates that the user device is stationary, thereby improving the resiliency against random noise. The measurement receiver module 242 can further apply a second damping constant when the accelerometer output indicates that the user is moving, thereby increasing the responsiveness to RSSI fluctuations. The filtered values can be stored in the observation array, such as by replacing the initially received measurements.

The device-locating module 244 can access the measurements and/or their filtered results and calculate the current location 220 of the corresponding user device in the building 104 accordingly. In some embodiments, the device-locating module 244 can include a multilateration mechanism (e.g., a Levenberg-Marquardt Multilaterator (LMM)) configured to locate the user device based on the received measurements (e.g., the signal strength measurements). For example, the multilateration mechanism can subscribe to notifications that represent updates to the observation array. On asynchronous updates, the multilateration mechanism can retrieve the latest information from the observation array and push a cycle request in a multilateration cycle queue (MCQ). The MCQ can process the queued requests and control the sequential initiation and termination of a problem solver in the multilateration mechanism. In some embodiments, the MCQ can cut awaiting requests upon insertion of a new request to prevent overflow. Accordingly, in some embodiments, the MCQ can ensure that the length of the queue is less than a predetermined number, and the system can thereby be responsive to the latest updates. In some embodiments, the device-locating module 244 can operate based on an event-driven model. Initially, the multilateration mechanism can subscribe for update notifications of the active measurement set. At an asynchronous update, the multilateration mechanism can receive the latest active observations from the active measurement set and push a cycle request in the MCQ. On a separate background thread, a control mechanism (e.g., a software function) can process queued requests and control the sequential instantiation and termination of the multilateration mechanism.

In calculating the current location 220, the device-locating module 244 can access the building map 116 of FIG. 1 that includes known locations of reference devices (e.g., one or more devices in the monitor network, such as beacon sources and/or signal receivers). In some embodiments, the linking devices 136 can function as the beacon source. The multilateration mechanism can identify the known locations of the reference devices that correspond to the strength measurements (e.g., the RSSI measurements). Using the measurements (e.g., the RSSI and/or the measured propagation delay), the multilateration mechanism can calculate distances between the user device and the corresponding reference devices. The multilateration mechanism can calculate the current location 220 as the location that matches the calculated distances from the corresponding reference devices. In some embodiments, the multilateration mechanism can further calculate an accuracy measure for the current location 220.

In some embodiments, the device-locating module 244 can store the current location 220 to serve as a prior location later and/or store the processed values (e.g., list of the signal sourcing devices and/or their associated measurements). The device-locating module 244 can prefetch the stored information for updating the current location 220. The device-locating module 244 can further access distance characteristics (e.g., an RSSI-distance characteristic (RDC)) calibration constants and/or the known locations of the previously utilized signal-sourcing/receiving devices. The device-locating module 244 can evaluate (e.g., when the user device 152 first enters the building 102 according to the occupant history 218 and/or at any time while the user device 152 is within the building 102) a calibration using the calibration constant and the measurement values against stored values that were generated during a prior calibration using devices similar to the user device 152. The distance values can be calculated accordingly. In calculating the current location 220, the device-locating module 244 can further filter the set of signals to utilize signals and/or measurements from reference devices that are located within a predetermined distance, such as by ignoring the RSSI measurements that fail to satisfy a threshold.

The device-locating module 244 can interact with the building control application 154 to calculate the current location 220 for each of the user devices 152. In some embodiments, the device-locating module 244 can calculate and/or adjust the current location 220 according to a dead-reckoning mechanism that calculates and combines displacements over time according to accelerometer readings of the corresponding device.

The servicing module 208 can communicate with the occupant location manager 206 and/or the building control application 154. In addition, servicing module 208 can be configured to control one or more aspects of the building 104 according to current locations of the user devices and/or information from one or more of the occupants. The servicing module 208 can receive or access the current locations from the occupant management module 202 and/or the occupant location manager 206, access or receive control inputs or requests from the building control application 154 of one or more of the user devices 152, or a combination thereof.

In some embodiments, the servicing module 208 can include a subsystem control module 252 (e.g., a portion of one or more linking devices 136 and/or the control module 102) configured to interact with and/or control one or more subsystems (e.g., the elevator system 122, the security system 124, the emergency system 126, the energy management system 128, the HVAC system 130, the CAFM 132, the BMS 134; all of FIG. 1, etc.) of the building 104. For example, the subsystem control module 252 can include a subsystem interfacing module 262 configured to enable interactions (e.g., query, report, command, etc.) between the corresponding subsystem and the system managing devices 112. In some embodiments, the subsystem control module 252 can include or be implemented by circuits and/or electrical connections (e.g., the linking devices 136) that link a previously stand-alone subsystem to the control module 102. In some embodiments, the subsystem control module 252 can include device/system drivers, application program interface (API), etc. configured to enable or facilitate interactions between the control module 102 and the previously stand-alone or unintegrated subsystem.

Also, the subsystem control module 252 can include an interactive decision module 264 configured to control one or more subsystems based on one or more parameters, such as the current locations, the occupant interactions, or other processing results. In some embodiments, the interactive decision module 264 can control one or more subsystems (e.g., the HVAC system 130, the BMS 134, etc.) and thereby control (e.g., by commanding specific settings, such as thermostat and/or fan settings) one or more aspects of the environmental conditions of the building 104. For example, the interactive decision module 264 can control the temperature in a conference room in preparation and/or during a meeting according to one or more requests/preferences of attendees. In some embodiments, the interactive decision module 264 can be configured to control the subsystems to control access to one or more building resources, such as by controlling doors, locks, and/or sign-ins for devices associated with offices, conference rooms, elevator bays, etc.

In some embodiments, the servicing module 208 can include a resource management module 254 configured to track use of resources associated with the building 104. For example, the resource management module 254 can coordinate space/resource assignments. The resource management module 254 can receive reservation requests for single occupant spaces (e.g., a cubicle, an office, or a room at a rental facility, such as a workshare space or a hotel), multiple-occupant spaces (e.g., conference rooms) via the occupant interface 204. The resource management module 254 can identify available spaces and filter them according to one or more characteristics (e.g., regarding devices and/or furniture, temperature, lighting, size, location, etc.) of the requested space. Accordingly, the resource management module 254 can assign the occupant space in response to the reservation request. Further, the resource management module 254 can track the location/usage of the requesting occupant based on storing the occupant location and/or interact with the servicing module 208 to provide an indoor route that guides the occupant through the building to/from the assigned space.

In various embodiments, the resource management module 254 can access the occupant profile 212 (e.g., the access set 214) in processing requests (e.g., for reservation and/or for controlling environmental settings). The resource management module 254 can determine a right or authorization of the occupant to make the requests using the access set 214 and process the requests accordingly. For example, the resource management module 254 can ignore or deny the environment setting request from visitors or occupants at non-assigned locations. Also, the resource management module 254 can allow the requesting occupant to book or reserve the spaces where the occupant is allowed to enter (such as, e.g., according to an occupant security level as specified in the access set 214). In some embodiments, when multiple occupants submit overlapping requests (e.g., for controlling the environmental conditions at the same zone or reserving the same space), the resource management module 254 can check the access set 214 of the requesting occupants for authorization levels, such as for administrative personnel or for occupants that subscribed (such as by paying higher fees) to have greater authority than non-subscribing occupants. Accordingly, the resource management module 254 can prioritize (such as by implementing the request in whole or by giving the requested parameters higher weight) the request of the occupant having greater authority.

Also, the resource management module 254 can record the environment setting request along with the time/duration of the request and/or the identification of the requesting occupant. Also, the resource management module 254 can include a scheduling calendar 266 (e.g., a database, a user interface, etc.) configured to reserve and/or track usage of conference rooms, occupant spaces (e.g., for daily, hourly, or other limited rental services/locations), furniture, devices (e.g., projectors, printers, etc.) provided by and/or stationary in the building 104, etc. The resource management module 254 can track the usage based on recording access or log-in information used to access the resources. The resource management module 254 can interface with the building control application 154 to record requests to reserve resources in the scheduling calendar 266. The resource management module 254 can further interface with the building control application 154 to show availability of resources for scheduling purposes.

In some embodiments, the servicing module 208 can include a routing module 256 configured to calculate routes for individual occupants. For example, in determining available or target resources, such as a newly assigned occupant space or a conference room, the routing module 256 can calculate routes of the occupant to the resources. In some embodiments, the routing module 256 can calculate comparison routes for available resources sought by an occupant to determine the nearest available resource. The routing module 256 can pass the routes and/or qualifying resources (e.g., nearest n resources) to the building control application 154 to inform the occupant. In some embodiments, the routing module 256 can calculate routes for occupants identified as a meeting participant in determining a conference room that would minimize overall travel distance of the participants. In some embodiments, the routing module 256 can calculate personal emergency routes 268 for evacuating the building 104 in emergency scenarios. The routing module 256 can use the sensed information (e.g., CCTV images, gas sensor readings, etc.) to determine the nature and/or location of the emergency (e.g., a fire, a medical emergency, a structural damage, etc.) and direct occupants accordingly. The routing module 256 can further determine the current locations of all occupants and calculate individualized evacuation routes that both avoid the location of the emergency and further provide crowd-control. Accordingly, the routing module 256 can decrease total evacuation time and/or decreasing exposure to dangers for the occupants during the emergency response.

In calculating the routes, the routing module 256 can utilize a combinatorial graph defined by the building map 116, estimated locations of structures/paths, locations or groupings of other occupants, etc. The routing module 256 can identify the pathways as directed edges or connections, and pathway junctions as nodes. Each directed edge can be assigned weights that represent quantities of interest (e.g., travel distance, walk time, etc.). In some embodiments, such as during emergencies, the edge weights may be updated (e.g., by the control module 102) to reflect the current state (e.g., travel speed and/or number of co-located occupants, etc.) of the building. To calculate the route, the routing module 256 can determine a starting location, such as by obtaining the current location 220 of the requesting device or by interacting with the occupant, and then map the starting location to a nearest node or edge. The routing module 256 can further determine a destination (e.g., occupant specified location, qualifying conference room, an emergency exit, etc.). The routing module 256 can use shortest-path calculation mechanism, such as A* mechanism, to calculate a route from the starting location to the destination. The routing module 256 can display the calculated route and/or provide turn-by-turn guidance for the occupant through the user device.

In some embodiments, the servicing module 208 can include an interior mapping module 258 configured to autonomously (e.g., without active or deterministic inputs from a human operator) map static (e.g., columns, walls, cubicle dividers, etc.) or semi-static objects (e.g., larger electronic devices, such as copy machines, refrigerators, etc.) within the building 104. The interior mapping module 258 can further map or locate partition-level structures (e.g., walls, dividers, cubicles, beams or columns, doors, pathways, etc.) within the building 104. For example, the interior mapping module 258 can be provided with (via e.g., user input and/or standard documents, such as blue prints) locations of the devices (e.g., the linking devices 136, the communication nodes 138, the sensors 140, etc.) in the monitoring network and/or the communication network and/or initial layout of the non-movable structures (e.g., walls, support columns, etc.). The interior mapping module 258 can additionally determine pathways based on tracking occupant movements throughout the building 104, such as determining continuous movements or travels across a sequence of locations. For example, the interior mapping module 258 can determine the path as a sequence of locations where, in a given duration, at least a predetermined number of occupants traverse without stopping.

The interior mapping module 258 can similarly use the tracked location to determine occupancy spaces. For example, the interior mapping module 258 can determine the occupancy spaces based on a set of locations where one or more occupants are repeatedly located without any threshold-exceeding movements (e.g., locations clustered within a standardized area size) for more than a predetermined duration. In some embodiments, the interior mapping module 258 can identify clusters of locations using one or more pattern-recognition mechanisms and determine the identified clusters as the occupancy spaces.

Based on the determined occupancy spaces and/or the paths, the interior mapping module 258 can estimate locations of structures or boundaries (e.g., larger office-objects, cubicle dividers, etc.) that likely exists around the determined pathways and/or the occupant spaces. For example, the interior mapping module 258 can include predetermined distances and/or an equation, such as for describing standard path widths and cubicle/office sizes, that determines the locations of the structures/boundaries relative to a center or edge location of the locations readings. The interior mapping module 258 can use the estimated structures and their locations to validate or reinforce the building map 116. In some embodiments, the interior mapping module 258 can periodically compare coordinates of location data (e.g., a recent set of data) to the estimated structures. When the location data overlaps with the location of an estimated structure, the interior mapping module 258 can reinitiate the estimation process.

In some embodiments, the interior mapping module 258 can autonomously determine and/or adjust control zones 260 in which environmental conditions are controlled by a set or a combination of subsystem components (e.g., a thermostat setting, a fan setting, etc.). Each of the control zones 260 can represent a space in which one or more environmental conditions (e.g., temperature) are uniquely affected by a set of controllable conditions, such as a setting for a fan, a heating/cooling coil, a light source, etc. located at one or more specific locations. In some embodiments, multiple separate control zones 260 can coexist within an open area (e.g., common/shared area and/or cubicle areas in an office) that includes multiple occupant spaces. In some embodiments, the control zones 260 can each include multiple occupant spaces. The control zones 260 can further be associated with prediction models that characterize likely environmental changes at and/or around the zones, over time, etc., such as models that predict dispersion of thermal energy over time and the corresponding temperature changes in an area.

In determining the control zones 260 and/or the prediction models, the interior mapping module 258 can track setting changes (e.g., thermostat settings, fan settings, etc.) and sensor measurements (e.g., temperature) over time, such as by storing the commanded settings and their time in a log. The interior mapping module 258 can analyze the tracked information for a pattern (e.g., a cause-and-effect relationship) between the setting changes and environmental changes measured by sensors at known locations. In analyzing the tracked information, the interior mapping module 258 can use an artificial intelligence mechanism, a pattern recognition mechanism, one or more computer-generated models, etc. For example, the interior mapping module 258 can use a clustering algorithm, Bayesian networks, etc., to determine control zones 260. Also, the interior mapping module 258 can use the associated predictive response models that are affected by a combination of controls and other real-time factors to determine the control zones 260. Also, the interior mapping module 258 can use information or models associated with air flow behavior, temperature dissemination characteristics, location/shape of estimated structures (e.g., pathways, walls, divisions, large objects, etc. estimated based on tracked locations of users), or a combination thereof to analyze the tracked information and/or generate the prediction model.

In some embodiments, the interior mapping module 258 can track one or more devices (e.g., projectors, whiteboards, and/or other sharable/rental equipment) associated with the building 104. The interior mapping module 258 can track the devices based on interacting with the device-locating module 244. The device-locating module 244 can locate the sharable/rental devices using one or more processes described above, such as by measuring beacon signals, translating them to distances, and multilaterating the locations based on the distances and known locations of beacon sources. Accordingly, the interior mapping module 258 and/or can use the locations to provide occupant (via the building control application 154) with the most recent information about the shareable/rental device when the occupant wants to book it, such as identified through the building control application 154.

In one or more embodiments, the interior mapping module 258 can implement self-localization of one or more devices (e.g., the linking devices 136, the sensors 140 including the presence sensors 142, the communication nodes 138, or a combination thereof) in the communication network and/or the sensor network. In some embodiments, for example, one or more of the devices can be configured to send and/or receive beacon signals for implementing the self-localization. Upon receiving the beacon signals, the devices can measure one or more characteristics of the received signal (e.g., the RSSI value) and send the measurements to the device-locating module 244. The device-locating module 244 can use the measurements to locate the devices relative to each other. In some embodiments, the device-locating module 244 can use the measurements to locate the devices relative to the building 104 based on known locations of one or more of the devices. In locating the devices relative to each other and/or relative to the building 104, the device-locating module 244 can use one or more of the processes (e.g., RSSI to distance conversion and/or multilateration) described above. The calculated locations of the devices can be passed back to the interior mapping module 258. The interior mapping module 258 can use the calculated locations to verify and/or adjust the building map 116. For example, the interior mapping module 258 can adjust the building map 116 to update the location of the corresponding device (e.g., the linking devices 136, the sensors 140, the communication nodes 138, or a combination thereof) when a predetermined number of consecutive reported locations are different from a previous location of the device.

In some embodiments, the servicing module 208 can include an emergency processing module 259 configured to detect and process emergency events. In some embodiments, the emergency processing module 259 can detect emergency events based on analyzing sensor readings from the linking devices 136, the sensors 140, etc. For example, the emergency processing module 259 can detect an earthquake based on accelerometer readings matching or exceeding one or more thresholds, a fire based on carbon monoxide/dioxide levels or temperature changes matching or exceeding one or more thresholds, identifying a weapon or a gunshot in captured images based on predetermined images/patterns, etc. In some embodiments, the emergency processing module 259 can estimate a direction of the gunshot, such as based on processing the captured image to determine an orientation of the shooter and/or the gun. In some embodiments, the emergency processing module 259 can detect a gunshot based on comparing characteristics of sounds captured by microphones in sensors (e.g., the linking devices 136, the sensors 140, etc.) to predetermined templates or thresholds.

In some embodiments, the emergency processing module 259 can determine one or more locations affected by the emergency event based on a measurement time, a measurement level, or a combination thereof associated with the emergency event. For example, the emergency processing module 259 can estimate a location of the fire based on locating which sensor first measured the temperature, the gases, etc. Also, the emergency processing module 259 can estimate the location of the fire based on a pattern of temperature changes measured across different locations, a pattern of gas detections across different locations, current temperature readings at various locations, etc. Also, the emergency processing module 259 can determine the affected locations based on analyzing CCTV feeds with image recognition mechanisms and predetermined images/patterns. The emergency processing module 259 can further use similar processes to estimate a severity of the emergency event. For example, the emergency processing module 259 can calculate a size of the fire, a spreading rate of the fire, etc. based on the sensor readings.

The emergency processing module 259 can implement a set of protocols associated with the identified emergency event. For example, the emergency processing module 259 can play pre-recorded instructions for the occupants to follow. Also, the emergency processing module 259 can communicate individualized information, such as the personal emergency routes 268 and/or associated turn-by-turn navigation, to each occupant through the user devices 152 and the building control application 154.

The billing module 210 can be configured to calculate costs for the building occupants. For example, the billing module 210 can calculate costs associated with the presence of occupants in the building or at specific locations therein, their use or consumption of resources, energy expenditure associated with the occupants, etc. The billing module 210 can calculate the costs according to various real-time parameters, such as the occupant locations, inputs or requests from the occupants (e.g., via the building control application 154), etc. For example, the billing module 210 can calculate the costs (e.g., based on multiplying the price with the duration) based on determining the occupant locations relative to various rooms or spaces (e.g., entertainment area, window seats, etc.) in the building 104, durations of the occupant stay, and the billing rates 216 for the locations. Also, the billing module 210 can calculate the costs associated with a baseline use, such as by dividing a predetermined total cost of maintaining baseline conditions by a total number of occupants. Also, the billing module 210 can calculate the costs associated with energy expenditures for the control zones 260 and/or the costs associated with the request to adjust one or more conditions in the control zones 260. The billing module 210 can calculate the costs by calculating a deviation from the baseline at the control zones 260, calculating a resource expenditure (e.g., an amount of gas/electricity) associated with the deviation, identifying a unit cost of the resource, and then combining the unit cost, the amount of expenditure, for the duration of the setting. Further, the billing module 210 can calculate the costs using real-time prices/rates and/or demands of the available energy, such as for day-to-day or seasonal gas prices, hourly electricity prices, etc. as listed by the resource provider.

### Linking Device

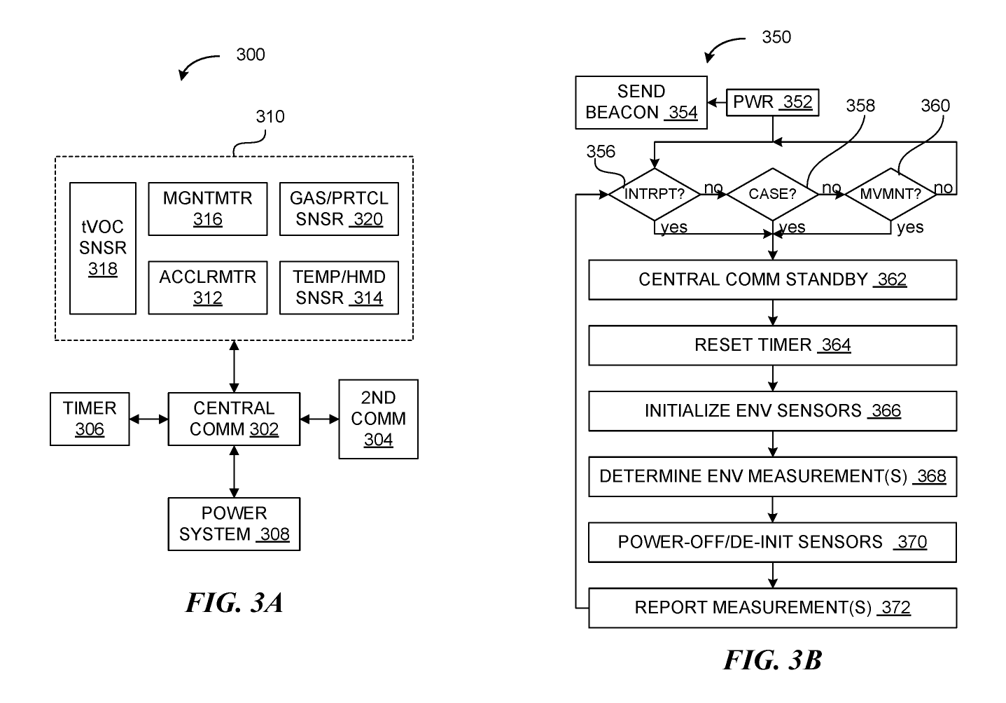

FIG. 3A is a block diagram of a linking device 136 configured in accordance with some embodiments. The linking device 136 can include one or more circuits configured to provide an interface between various devices/systems for a building-resource management system (e.g., the building-resource management system 100 of FIG. 1). In some embodiments, the linking device 136 can be a surface-mount device including attachment mechanisms (e.g., a mounting portion including an adhesive, a nail, a screw, a cable tie, etc.) configured to attached to a surface of a structure (e.g., a wall, a column, a ceiling, a column, a divider, a floor, etc.) in or of the building 104 of FIG. 1.

In some embodiments, the linking device 136 can include a central communication circuit 302 connected to a second communication circuit 304, a timer circuit 306, a power system 308, one or more onboard sensors 310, or a combination thereof. In some embodiments, the circuits can be connected using UART connections/bus, direct communication connections (e.g., traces on printed circuit boards), a serial peripheral interface (SPI), an inter-integrated circuit (I2C) communication, and/or other circuit-to-circuit or device-to-device communication mechanisms.

The central communication circuit 302 (e.g., a processor, onboard memory, a transmitter, a receiver, etc.) can be configured to provide an interface (such as, e.g., based on mapping commands, signals, information, etc. according to formats recognized by the connected devices/systems) between the control module 102 and the building subsystems, building occupants (e.g., the user devices 152 of FIG. 1), the environmental sensor 310, or a combination thereof. In some embodiments, the central communication circuit 302 can include a sub-GHz communication circuit, one or more antenna, an Ethernet port/circuit, a wireless LAN connector/circuit, etc. for facilitating the communication between the devices/systems. The central communication circuit 302 can further include a control circuit (e.g., a microcontroller, a processor, etc.) configured to provide initial processing and/or internal control over one or more operably connected circuits.

The second communication circuit 304 can be configured to provide an interface (such as, e.g., by mapping commands, signals, information, etc. according to formats recognized by the connected devices/systems) between the central communication circuit 302, and thereby the control module 102, and one or more building subsystems and/or the building occupants. For example, the second communication circuit 304 can include a wired or wireless direct communication interface/connection to the building systems, such as systems/devices described above. Also, the second communication circuit 304 can include a wireless communication interface (e.g., a Bluetooth interface, a wireless LAN interface, antenna, etc.) configured to interface/connect to the user devices 152.

The timer circuit 306 can be configured to facilitate an operating cycle for the linking device 136. The timer circuit 306 can provide an interrupt at one or more predetermined intervals (e.g., various timing/accuracy modes) for operating one or more circuits in the linking device 136. In some example embodiments, the timer can provide an interrupt signal every 15 minutes that initiates sensor measurement and reporting of the sensor measurement. Once the environmental measurements have been made and reported, the linking device 136 can power down one or more circuits or cause them to stay in standby mode until the next interrupt, thereby reducing power consumption. In some embodiments, the functions of the timer circuit 306 can be included in or shared with other circuits, such as the onboard sensors 310. For example, the onboard sensors 310 in standby mode can generate the interrupt to initiate reporting of the sensor measurements. As an illustrative example, the temperature-humidity sensor 314 can be configured (via, e.g., coarser measurement circuit, a temperature-based breaker, and/or reduced sampling frequency) to monitor the ambient temperature for one or more extreme conditions while in standby mode. When the temperature-humidity sensor 314 senses an extreme condition (e.g., a fire as represented by a temperature reading exceeding a corresponding threshold), the temperature-humidity sensor 314 can generate the interrupt to initiate the reporting process. Details regarding the operating sequence and the timer circuit 306 are discussed below.

In some embodiments, the power system 308 can include one or more batteries or a connection to a building power system, a power control circuit (e.g., a voltage regulator), etc. configured to power the circuits within the linking device 136. In some embodiments, the power system 308 can include a transformer that provides 3.3V for powering the internal circuits of the linking device 136. The output from the battery can be set to the output of the voltage regulator when the battery voltage falls below 3.3V.

The linking device 136 can include the onboard sensors 310 configured to determine corresponding environmental conditions in the building 104. In some embodiments, the onboard sensors 310 can include an accelerometer 312, a temperature and/or a humidity sensor 314, a magnetometer 316, a total volatile organic compounds (tVOC) sensor 318, a gas or particle sensor 320, etc. In some embodiments, the onboard sensors 310 can further include other sensor circuits, such as a camera, an ambient noise detector, a light sensor, a presence sensor (e.g., passive infrared (PIR) presence sensors), a capacity sensor, a mmWave radar, a barometric sensor, a gyroscope, or a combination thereof. In some embodiments, the linking device 136 can include a modular design that can be configured to include a different combination of sensors, communication circuits, etc. In some embodiments, the linking device 136 can include a user interface circuit configured to directly communicate with building occupants. For example, the linking device 136 can include a camera for receiving motion commands, a microphone for receiving voice commands, a touch-interface, etc.

FIG. 3B is a flow diagram illustrating an example process 350 for operating the linking device 136 of FIG. 3A according to some embodiments. As illustrated in FIG. 3B, the process 350 is associated with measuring the environmental conditions in the building 104 of FIG. 1 and reporting them to the control module 102 of FIG. 1. The process 350 can initiate with a power-on/initialization event as illustrated at block 352. Once the linking device 136 initializes, at block 354, the linking device 136 (e.g., the central communication circuit 302, the second communication circuit 304, etc. as shown in FIG. 3A) can regularly broadcast beacon signals. For example, the linking device 136 can transmit a beacon frame (e.g., based on one or more wireless communication protocols, such as Bluetooth) according to a predetermined interval (e.g., 200 ms) during operational state of the linking device 136.

At decision block 356, the linking device 136 (e.g., via the timer circuit 306 of FIG. 3A and/or the onboard sensors 310) can determine whether an interrupt has occurred, such as generated by the timer circuit 306 according to a predetermined interval (e.g., 15 minutes) or by one or more of the onboard sensors 310 as described above. At decision block 358, the linking device 136 (via e.g., a connection/continuity circuit) can determine whether its outer case is open or compromised. At decision block 360, the linking device 136 (e.g., the accelerometer 312 of FIG. 3A) can determine whether the linking device 136 has moved or is moving, such as by identifying an accelerometer reading that exceeds a threshold magnitude. If none of the tested events have occurred (e.g., the timer has not expired, the case has not been opened, and the device has not moved), the process 350 can repeat, such as by looping through decision blocks 356, 358, and 360.

At block 362, if the interrupt event has occurred, if the case has been opened, and/or if the device has moved, the central communication circuit 302 of FIG. 3A can be initialized. For example, the central communication circuit 302 can transition from a shutdown state to a standby state. At block 364, the timer circuit 306 can be reset (e.g., counter value set to 0). At block 366, the onboard sensors 310 of FIG. 3B can be powered on and/or initialized. At block 368, the linking device 136 can measure, after a settling delay in some embodiments, the conditions of the surrounding environment using the onboard sensors 310 (e.g., the temperature-humidity sensor 314, the magnetometer 316, the tVOC sensor 318, the gas-particulate sensor 320, etc.). Once the measurements of the conditions have been made, at block 370, the linking device 136 can power-down or de-initialize the sensors or switch to a standby mode. In some embodiments, the central communication circuit 302 can receive and/or store, such as using onboard memory, a temperature measurement and/or a humidity measurement from the temperature/humidity sensor 314. Afterwards, the temperature/humidity sensor 314 can be powered off. Also, the central communication circuit 302 can receive and/or store one or more measurements from the other sensor circuits. Subsequently, the sensor circuits can be powered off or de-initialized to reduce power consumption.

At block 372, the linking device 136 (e.g., the central communication circuit 302) can report the received sensor measurements to the control module 102. In some embodiments, the linking device 136 can further perform a status check, such as for evaluating battery power, and report the status to the control module 102. The linking device 136 can power-off or de-initialize the remaining circuits (e.g., the central communication circuit 302) after the measurements have been reported. Accordingly, while the power remains at sufficient levels, the linking device 136 can wait for another wake up event, such as represented by the decision blocks 356-360.

Processing of Information Associated with Internal Spaces within a Building

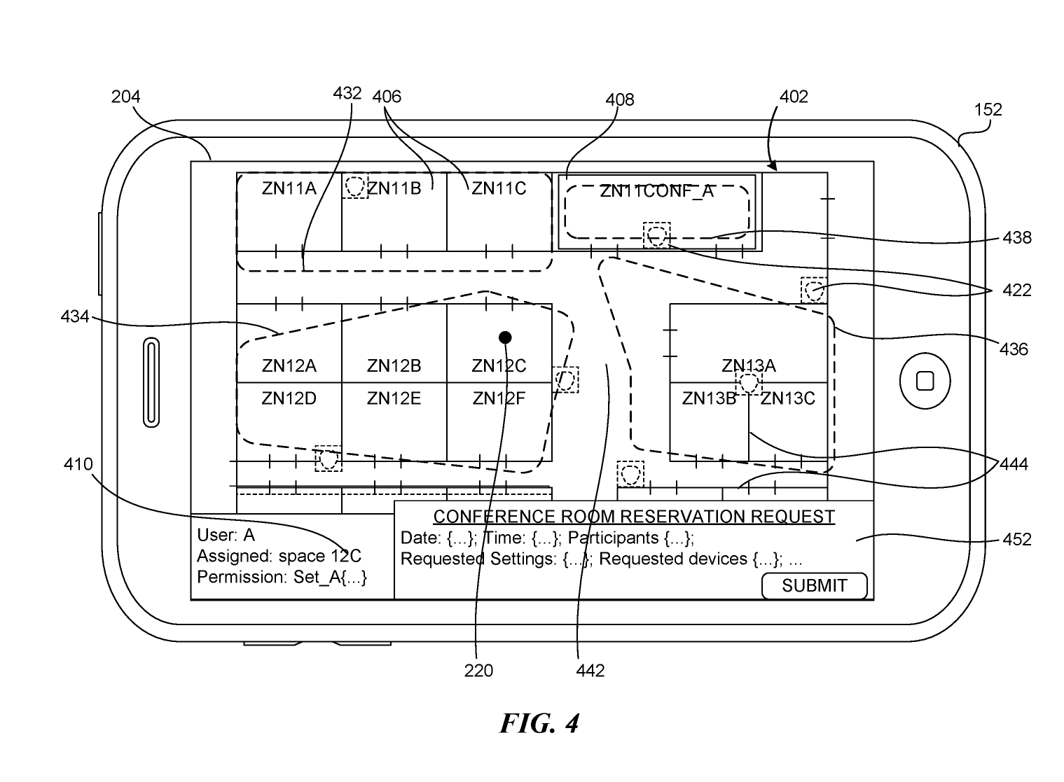

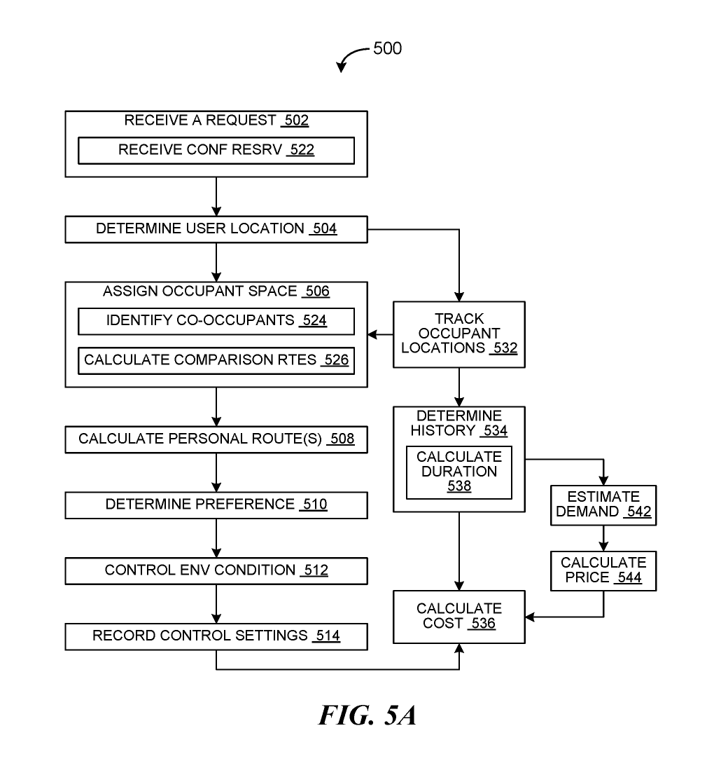

FIG. 4 illustrates an example user device 152 of FIG. 1 having the occupant interface 204 of FIG. 2 according to some embodiments. For example, the building control application 154 of FIG. 1 can cause the user device 152 to implement the occupant interface 204 to show a floor map (e.g., a portion of the building map 116 of FIG. 1) of a unit space 402 in the building 104 of FIG. 1. The unit space 402 can include a portion of the space within the building 104 that is enclosed (e.g., surrounded by walls) and/or corresponds to a single organization/group, purpose, or renter. In some embodiments, the unit space 402 can correspond to an office space rented by an organization, a shared workspace, or a coworking space. In other embodiments, the unit space 402 can correspond to residential spaces, etc.

The floor map can illustrate actual and/or estimated locations of various features, objects, and/or occupants in the building 104. For example, the floor map can display locations of occupant spaces, such as single-occupant spaces 406 (e.g., personal offices or cubicles) and/or multi-occupant spaces (e.g., a conference room 408). In some embodiments, the occupant interface 204 can be used by a device user to reserve and/or assign one of the single-occupant spaces 406 and/or the conference room 408 for an occupant. For example, a device user can use the building control application 154 of FIG. 2 (e.g., the occupant interface 204 of FIG. 2) to submit a space assignment request 452 to access/reserve an occupant space. The building control application 154 can receive other associated parameters, such as a requested date and time/duration for the use, a number and/or identities of meeting participants or co-occupants, etc. and include them in the space assignment request 452. In some embodiments, the space assignment request 452 can include a desired environmental setting (e.g., brightness, temperature, etc.), a necessary device (e.g., computer or projector access), a requested service, or a combination thereof. In some embodiments, as an illustrative example, the building control application 154 can interact with the device user (via, e.g., prompts, user commands or selections, etc.) to receive the information associated with the request. In some embodiments, the building control application 154 can autonomously generate the request based on identifying occupants that previously reserved spaces/facilities through the building control application 154, accessing the corresponding occupant profile 212 of FIG. 2 (e.g., for previous requests and/or specified preferences), and generating the space assignment request 452 according to the previous requests/preferences. Using a predefined process and/or format, the building control application 154 can arrange the received/accessed information as the space assignment request 452 and communicate it to the control module 102 of FIG. 1 (e.g., the resource management module 254 of FIG. 2).

Upon receiving the space assignment request 452, the control module 102 can search for available occupant spaces (e.g., according to a status log maintained by the servicing module 208) that match the requirements of the request. When one or more matching occupant spaces are identified, the control module 102 can assign one of the identified spaces (e.g., the space best matching the requested parameters according to a scoring mechanism and/or based on a user selection/confirmation) to an occupant as an assigned space 410. Once the assigned space 410 is determined, the control module 102 can calculate a personal interior route that guides the assigned occupant through the unit space 402/the building 104 to or from the assigned space 410, such as for temporary or first-time renters at the unit space 402. Accordingly, the control module 102 can communicate the personal interior route to the occupant through their user device via the building control application 154 to provide turn-by-turn navigation through the building 104/the unit space 402 substantially in real-time (e.g., as the occupant traverses the route).

In some embodiments, the building map 116 can include locations of components (e.g., HVAC fans, AC vents, thermostats, etc.) of environmental control devices/systems (e.g., the HVAC system 130) and/or sensors (e.g., the linking devices 136 and/or the sensors 140). The building map 116 can thus include locations of energy inputs or influences that affect the environmental conditions within the building along with locations of devices that can measure the resulting environmental conditions. For example, as shown using small-dashed lines in FIG. 4, the building map 116 can include component locations, such as for HVAC source locations 414 (e.g., fans, thermostats, heating/cooling element, etc.), HVAC vent locations 416, light source locations 418, etc. The building map 116 can further include sensor locations 422 that represent known locations of the communication nodes 138, the sensors 140, the linking devices 136, etc., which are all illustrated in FIG. 1.

The building map 116 can further include one or more control zones (e.g., a first control zone 432, a second control zone 434, a third control zone 436, etc.). Each control zone (illustrated using long-dashed lines in FIG. 4 for its boundaries) can include an open or connected space within the unit space 402 (e.g., within its outer boundaries). In each control zone, the environmental conditions can be directly affected by a unique combination of subsystem components and their settings. For example, the control zones can include a portion of a common or open area (e.g., as defined by office/room walls), a set of single occupant spaces (e.g., a set of cubicles), etc. that correspond to one or more specific sources (e.g., a thermostat, a fan, a vent, a light, etc.). In some embodiment, the control zones can correspond to temperature gradients and/or models that account for conditions at adjacent zones.

The building map 116 can further include enclosed zones 438 that correspond to spaces within the unit space 402 that are further enclosed or separated from the open area. For example, the enclosed zones 438 can correspond to private/personal offices, privacy rooms, conference rooms, etc. that have its own set of walls and doors. As illustrated in FIG. 4, the enclosed zone 438 for the conference room in zone 11 can correspond to an HVAC source and an HVAC vent located in the conference room.

In some embodiments, the control module 102 can track the current location 220 of one or more mobile devices (e.g., the user devices 152) over time. For example, the control module 102 can store the current location 220 with corresponding time stamp to determine the location history 222 of FIG. 2 of each user device. Using the location history 222 of one or more devices, the control module 102 can estimate pathways 442 (e.g., corridors, walkways, hallways, etc.) that occupants can traverse to and/or from the various occupant spaces. For example, the control module 102 can estimate the pathways 442 as portions of the space that include a sequence of locations that are determined within a movement-determination threshold (e.g., representative of an occupant walking). Also, the control module 102 can estimate the pathways 442 when one or more users traverse through the determined space with a predetermined frequency and/or more than a threshold number of occurrences over a predetermined period. In some embodiments, the control module 102 can use information provided by one or more occupants and/or building administrators.

In some embodiments, the control module 102 can estimate structure locations 444 that represent locations of larger objects (e.g., cubicle dividers, machines, etc.) placed in the unit space 402 and/or structures (e.g., walls, columns, etc.) connected to or integral with the building 102. In some embodiments, as described in detail below, the control module 102 can estimate structure locations 444 based on the pathways 442, temperature changes that occur after activation/setting changes at the HVAC source 414, information from occupants or building administrators, etc. For example, the control module 102 can estimate the structure locations 444 for walls or dividers bordering or defining the estimated pathways 442 based on a template size or location of pathways and/or relative locations of the boundaries. Also, the control module 102 can estimate the structure locations 444 to be between an HVAC source location and a sensor location when the sensor at the location does not respond to activation of the HVAC source within a predetermined threshold duration.

### Flows for a Building-Resource Management System

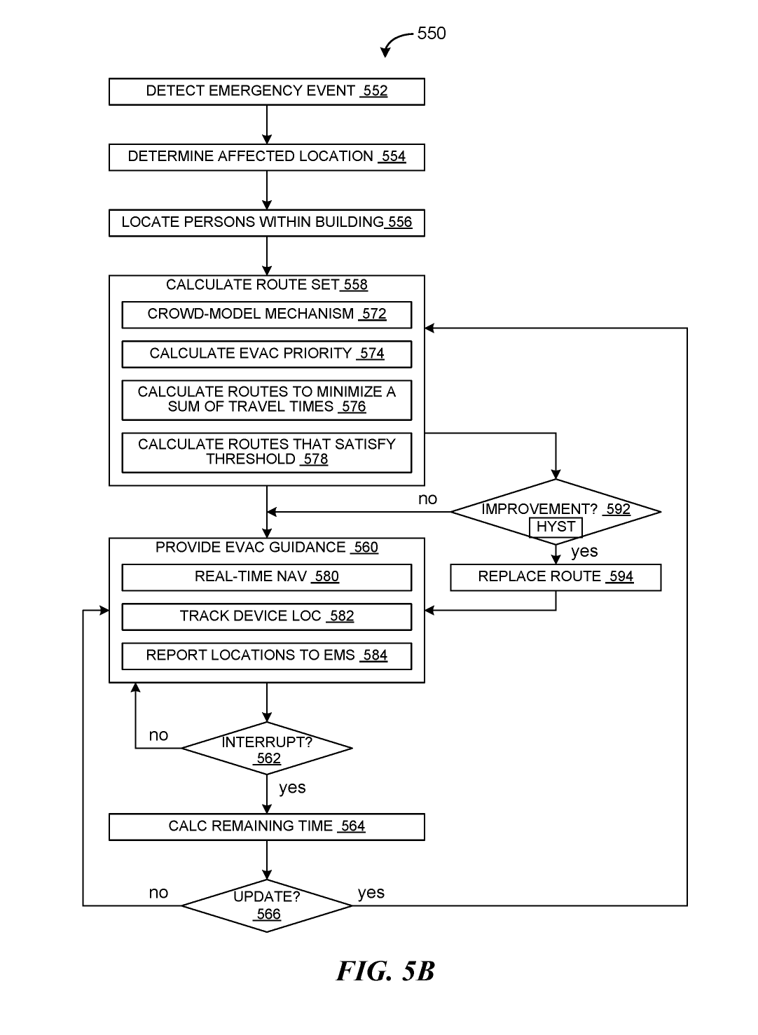

FIG. 5A is a flow diagram illustrating an example process 500 for implementing a building-resource management system (e.g., the building-resource management system 100 of FIG. 1 or a portion thereof) according to some embodiments. The process 500 can be implemented via one or more of the devices illustrated in FIG. 1, such as the user devices 152, the system managing devices 112, the linking devices 136, or a combination thereof. The process 500 can be implemented using the modules/components illustrated in FIG. 2, the occupant interface 204 of FIG. 2, the system management interface 114 and/or the control module 102 of FIG. 1, or a combination thereof.

At block 502, the building-resource management system 100 (e.g., the subsystem control module 252 of FIG. 2, etc.) can receive a request (e.g., the space assignment request 452 of FIG. 4) from a device user to use and/or reserve an occupant space (e.g., one or more spaces illustrated in FIG. 4, such as the single-occupant spaces 406 and/or the conference room 408). For example, at block 522, the building-resource management system 100 can receive the space assignment request 452 at the system managing devices 112 via the communication network 103 of FIG. 1 (e.g., the linking devices 136 and/or the communication nodes 138). As an illustrative example, the space assignment request 452 can be generated by the user device 152 based on interacting with the user (as described above) to include a request to use an occupant space at a workshare space. The user device can format the information received from the device user into the space assignment request 452 and send it to the system managing devices 112 through the linking devices 136, the communication nodes 138, other components in the communication network, etc.

In some embodiments, the building-resource management system 100 can generate (e.g., without direct input from the occupant) the space assignment request 452 based on previously received preferences or reservation requests. For example, instead of requiring a frequent occupant/renter to submit their requests each time, the control module 102 can store the occupant preferences and/or previous reservation requests in the occupant profile 212 of FIG. 2. As an illustrative example, when the previous occupant enters the building 104 or a certain zone, the occupant management module 202 can identify the corresponding user device 152 as part of a regular communication maintenance function (e.g., device scanning process). The occupant management module 202 can compare the user device 152 (e.g., a device/communication identifier of the device) to the allowed occupant list 211 (e.g., a device list therein) and/or the occupant history to identify the device user as a previous occupant. The occupant management module 202 can identify the occupant history 218 of the identified previous occupant and use preference parameters in the previous (e.g., most recent) reservation request to autonomously generate the space assignment request 452 for the current time.

At block 504, the building-resource management system 100 can determine the occupant location. The building-resource management system 100 can determine the occupant location at various times, such as in response to receiving the request and/or as part of periodically (e.g., according to regular intervals) locating all occupants within the building 104. In determining the occupant locations, the building-resource management system 100 (e.g., the occupant location manager 206 and/or the location processing module 232 illustrated in FIG. 2) can interact with the occupant mobile device (e.g., the user device 152, such as a wearable device or a smart phone) as described above to determine its current location 220 of FIG. 2, which can represent the location of the occupant. As an illustrative example, in some embodiments, the linking devices 136 and/or the communication nodes 138 can regularly transmit beacon or reference signals for locating mobile devices. The user devices 152 can detect the various beacon signals and measure a characteristic (e.g., signal strength, such as for RSSI, a transmission delay, etc.) of the signal that is affected by a transmission distance. In some embodiments, the user device 152 can use the measurements to calculate its own location (e.g., the current location 220), such as by implementing the multilateration process described above, and send the current location 220 to the control module 102. In some embodiments, the user devices 152 can send the measured characteristics to the control module 102 (e.g., the system managing devices 112, the linking devices 136, etc.). In some embodiments, the user devices 152 can calculate intermediate results (e.g., distance estimates) based on the measured characteristics and send the intermediate results to the control module 102 instead of the measurements. Accordingly, the control module 102 can implement the multilateration process described above to calculate the current location 220 using the received values.

The current location 220 of a mobile device can be calculated using a multilateration mechanism (e.g., using a multilaterator, such as a Levenberg-Marquardt Multilaterator (LMM), a multilateration cycle queue (MCQ), etc.). For example, the characteristics measured at the mobile device can be used to estimate separation distances between the mobile device and corresponding reference devices (e.g., the linking devices 136, the communication nodes 138, etc.) that transmitted the detected beacon signals. The distance estimates can be combined with known locations of the beacon transmitters, such as indicated in the building map 116, to calculate the current location 220 of the user device. In some embodiments, the measured characteristics can be filtered (e.g., using one or more damping constants) based on device acceleration data as described above.

At block 506, the building-resource management system 100 (e.g., the resource management module 254 of FIG. 2) can assign an occupant space for use by the requesting occupant. The building-resource management system 100 can determine the assigned space 410 of FIG. 4 (such as by selecting one of the available spaces that best matches the requested parameters) in response to the space assignment request 452 for use by the requesting occupant. The building-resource management system 100 can determine the assigned space 410 according to various parameters. As an illustrative example, the resource management module 254 can analyze the scheduling calendar 266 to identify the occupant spaces that are available at the date and time specified in the space assignment request 452. From the available set of occupant spaces, the resource management module 254 can determine the set of spaces that match other details (e.g., a location, a size, a facility or a device, etc.) specified in the space assignment request 452. In some embodiments, the building-resource management system 100 can estimate a cost for the use and present it (via, e.g., the occupant interface 204) to the requesting user. The resource management module 254 can interact with the building control application 154 to present (via, e.g., the occupant interface 204) the available spaces and/or confirm reservation/assignment of the space to the user. Accordingly, the confirmed space can be identified as the assigned space 410 for the requesting occupant.

In some embodiments, the resource management module 254 can use a similar process to determine the occupant space that accommodates multiple occupants. For example, at block 524, the resource management module 254 can identify co-occupants, such as meeting participants, for the requested occupancy space. The resource management module 254 can identify the co-occupants based on a list or a common characteristic that links multiple members. In some embodiments, the resource management module 254 can identify the co-occupants based on the names or contact information listed in the space assignment request 452, such as a listing of the meeting participants provided by the requesting user via the occupant interface 204. In some embodiments, the resource management module 254 can identify the co-occupants based on their title, enrollment information (e.g., groups or departments), subscription information (e.g., email groups or service subscriptions), etc. as it relates to a meeting title and/or the requesting user.

At block 526, the resource management module 254 can calculate (via, e.g., the example process described above in association with the routing module 254) comparison routes (e.g., routes from the current or estimated locations to candidate conference rooms) for each of the co-occupants in determining the occupant space. The resource management module 254 can interact with the occupant location manager 206 of FIG. 2 and/or the occupant management module 202 to access the current or estimated (e.g., based on the location history 222 of FIG. 2) locations of the co-occupants at the requested reservation time. Based on the locations, the resource management module 254 can interact with the routing module 256 to access the comparison routes and their characteristics (e.g., path/node weights that correspond to distances and/or travel times) for each of the occupants to the available spaces. The resource management module 254 can select the occupant space that provides the most accessibility (e.g., shortest overall travel distance, shortest travel time, shortest maximum travel time/distance, etc.) for the co-occupants. The resource management module 254 can communicate (e.g., as a recommendation or a suggestion) the selected conference room 408 and determine the selected conference room as the assigned space 410 based on user confirmation.

At block 508, the building-resource management system 100 (e.g., the routing module 256) can calculate personal route(s) (e.g., using the example processes described above in relation to the routing module 256) for the assigned occupant. For example, for a first-time occupant at the building 104, the routing module 256 can calculate the personal routes and provide turn-by-turn navigations to and/or from the assigned space. Also, the routing module 256 can calculate the personal routes for each of the co-occupants or meeting participants to the assigned space/conference room to attend the meeting on time. In some embodiments, the routing module 256 can calculate the personal emergency route 268 of FIG. 2 for each of the building occupants in response to a detected emergency. Details regarding the personal emergency route 268 are described below.

At block 510, the building-resource management system 100 (e.g., the subsystem control module 252 of FIG. 2) can determine one or more preferences of the assigned occupant. For example, the subsystem control module 252 can determine the occupant preferences (e.g., for the environmental conditions in the building, such as ambient temperature, brightness, air flow, etc.) according to the occupant profile 212 of FIG. 2 and/or information provided directly by the assigned occupant to the occupant preferences.

At block 512, the building-resource management system 100 (e.g., the subsystem control module 252 of FIG. 2) can control one or more subsystem component settings to adjust/maintain the environmental conditions at the assigned space. The subsystem control module 252 can first determine one or more system component settings that correspond to the occupant preferences and/or separate requests. The subsystem control module 252 can determine specific settings for a combination of subsystem components for operating the subsystem to adjust the environmental condition at the assigned space. For example, the control module 102 can determine the component settings such as a fan speed, a thermostat setting, a heating and/or a cooling level, etc. for one or more fans, vents, heating elements, cooling elements, etc. of the HVAC system 130 of FIG. 1. The subsystem control module 252 can use a computer model or a lookup table to determine one or more components and their settings that will likely adjust the environmental conditions to a targeted level.

In some embodiments, the building-resource management system 100 can determine the system component settings according to authorization and/or status of the occupants and/or visitors in the applicable zone. For example, the subsystem control module 252 can ignore requests form non-authorized occupants and/or assign higher weights to authorized occupants in determining the targeted level (e.g. via a weighted averaging process). When there are more than one authorized occupants located in the zone, the subsystem control module 252 can determine the system component settings based on averaging (e.g., using weights that correspond to authorization or service levels) the preferences or submissions from other users with the requested conditions.

Based on the determined component settings, the building-resource management system 100 can control the environmental conditions at the applicable zone. For example, the subsystem control module 252 can communicate (e.g., via a request or a command) the system component settings that specify components and their settings to the applicable subsystem, such as the HVAC system 130. Upon receiving the system component settings 523, the subsystem can operate the specified components according to the settings to control the environmental condition.

At block 514, the building-resource management system 100 can record the system control settings with a time stamp. For example, in a system log, the occupant management module 202 and/or the servicing module 208 can record the system component settings with a time stamp that corresponds to the communication to the subsystem or a confirmation reply from the subsystem. In some embodiments, the building-resource management system 100 can record the identity of the assigned occupant in the log, which the occupant management module 202 can use to generate the resource usage history 224 for the occupant.

In some embodiments, the building-resource management system 100 can implement parallel processing of the occupant information for other associated purposes. For example, at block 532, the building-resource management system 100 (e.g., the occupant management module 202) can track occupant locations. The occupant management module 202 can track the occupant locations based on storing the current location 220 associated with each occupant along with a time stamp in a data structure or a database. At block 534, the control module 102 (e.g., the occupant management module 202) can group the stored locations according to the occupant to determine their location history 222 of FIG. 2. Further control module 102 can store the space assignment request 452 and the received time according to the occupant to determine their usage history 224.

In some embodiments, such as illustrated at block 538, the control module 102 can calculate a duration associated with the occupant stay at a location and/or a duration associated with their resource usage/consumption. For example, the control module 102 can calculate the occupant stay duration based on identifying a displacement that exceeds a threshold distance/pattern, and then calculating a difference in the time stamps between the qualifying locations. Also, the control module 102 can calculate the occupant usage/consumption duration based on identifying a change in the subsystem component setting, such as after the space assignment request 452 has been implemented, and then calculating a difference in the time stamps between the qualifying events.

In some embodiments, the control module 102 can include components or submodules (e.g., the billing module 210 of FIG. 2) configured to calculate a cost or a fee associated with occupancy and/or use of facilities or resources of the building for each of its occupants. For example, as illustrated in block 536, the billing module 210 can calculate a cost for the occupant usage of the assigned space. The billing module 210 can calculate the cost for each occupant by applying one or more billing rates 216 of FIG. 2 to the stay duration according to the occupant location histories and/or resource usages.

In some embodiments, the billing module 210 can calculate cost or share for each occupant in the building utility bills based on calculating a total expenditure (e.g., a cost) for establishing or maintaining environment conditions (e.g., a base or standard ambient temperature) at each of the assigned spaces. In some embodiments, the billing module 210 can calculate a cost or share for each occupant according to their space assignment request 452. For example, the billing module 210 can charge the occupant according to the reserved duration, the reservation date/time, the number of co-occupants, the requested environmental conditions, etc.

As a further example of the parallel processing, in some embodiments, the building-resource management system 100 can dynamically price the cost of using the assigned space according to real-time or current demands. At block 542, the building-resource management system 100 (e.g., the resource management module 254) can estimate a demand for the occupancy spaces in the building 104. The building-resource management system 100 can estimate the demand based on past usage/occupancy history, such as according to a season, a particular time/day/week/month/etc., a reservation pattern, or a combination thereof. In some embodiments, the building-resource management system 100 can receive notices (e.g., via a subscription service or manually entered notices) that correspond to events (e.g., leisure or entertainment events and/or professional or business events) that are scheduled to take place within a threshold distance from the building 104. The building-resource management system 100 can estimate the demand based on a type, a proximity, and/or a size (e.g., an attendance capacity of the scheduled location and/or a previous revenue or attendance record for recurring events) of the event. In some embodiments, for example, the resource management module 254 can calculate the demand as a percentage increase in the average usage rate that corresponds to one or more specific aspects of the event using one or more factors (e.g., plus or minus a predetermined percentage) in a predetermined lookup table that correspond to various aspects of the event.

At block 544, the building-resource management system 100 can calculate prices (e.g., the one or more billing rates 216) for using the occupancy spaces. The building-resource management system 100 (e.g., the resource management module 254) can calculate the billing rates 216 according to the estimated demand. In some embodiments, the resource management module 254 can include a mechanism (e.g., a predetermined formula or equation) to calculate the billing rates 216 that correspond to the estimated demand. The resource management module 254 can calculate the billing rates 216 based on increasing/decreasing a base rate according to the percentage factor corresponding to the estimated demand. In some embodiments, the resource management module 254 can receive real-time updates for utility (e.g., electricity, water, etc.) prices, and calculate the billing rates 216 accordingly (e.g., by adjusting the utility prices in the price calculation mechanism).

By tracking the current location 220 of the user devices 152 in the building 104 and providing internal routes (e.g., the personal interior routes) to/from the assigned spaces provides improved usability for the occupants. For example, people utilizing resources (e.g., office/conference spaces, rooms, presentation booths, other spaces and/or associated facilities) in the building 104 for a relatively short amount of time, such as in hotels, workshare spaces, convention centers, etc., may not be familiar enough with the building 104. Also, for larger organizations that rent/occupy multiple floors and/or buildings (e.g., in an office park), an occupant or an employee may not be familiar with the layout of other floors or different buildings. Using the building control application 154, the occupant can interact with the control module 102 and take advantage of the turn-by-turn guidance substantially in real-time, such as to and/or from the occupant assigned space. The building-resource management system 100 can further locate and track a group of linked occupants (e.g., sharing a common employer, project, event, meeting, etc.) and provide them with locations and facilities (e.g., conference rooms) that best suits their needs, such as by minimizing the total overall travel time/distance or other processes as described above for collaborative efforts.

Further, based on tracking the current location 220 of the user devices 152, the building-resource management system 100 can provide location-specific control/access to the building 104 and its facilities. For example, an occupant can have a wider range of controls, such as for temperature settings and/or brightness, when the occupant is at the occupant assigned space. However, the occupants may not have the access or control when they travel outside of their assigned space.

FIG. 5B is a flow diagram illustrating a further example process 550 for implementing a building-resource management system (the building-resource management system 100 of FIG. 1 or a portion thereof) according to some embodiments. The process 550 can be similar to the process 500 of FIG. 5A in the implementation details, such as in the devices, modules, components, interfaces, etc. used to implement the processes. In some embodiments, the process 550 can be implemented in parallel with the process 500.

In some embodiments, the process 550 can implement protocols and guide occupants in the building 104 of FIG. 1 in the event of an emergency. At block 552, the building-resource management system 100 can detect an emergency event. In some embodiments, for example, the emergency processing module 259 can monitor the sensor readings generated by the linking devices 136 of FIG. 1, the sensors 140 of FIG. 1, or a combination thereof. The emergency processing module 259 can analyze (e.g., based on comparing to threshold levels or predetermined templates) the sensor readings substantially in real-time to detect predetermined conditions that represent various emergencies. For example, the emergency processing module 259 can detect a fire when a temperature or gas measurement exceeds a threshold level, when a fire-alarm interface or a suppression system has been activated, or a combination thereof. Also, the emergency processing module 259 can detect an earthquake when acceleration data from multiple sensors located at different points in the building 104 simultaneously exceed a threshold level. Also, the emergency processing module 259 can detect a shooting and/or any associated parameters (e.g., a location and/or an estimated direction of the shot) as described above.

At block 554, the building-resource management system 100 can determine one or more locations in the building that are associated with the emergency event. The emergency processing module 259 can analyze the sensor data to determine the one or more locations affected by the emergency event. For example, the emergency processing module 259 can estimate the location of an emergency source (e.g., fire, sounds, etc.) using a process similar to the occupant location process described above. As a more specific illustration, the emergency processing module 259 can convert measured magnitudes (e.g., temperatures/gas levels for a fire, decibels for sounds) from sensors into distances. The emergency processing module 259 can map the distances to the known locations of the sensors that measured the magnitudes and use a multilateration process described above to estimate a location of the emergency source. In other embodiments, for example, the emergency processing module 259 can determine the affect locations based on analyzing images (e.g., CCTV images) for patterns matching predetermined templates/patterns (e.g., pixel patterns corresponding to structural failures or fires). In other examples, the emergency processing module 259 can determine the one or more affected locations to include locations of sensors that are reporting defective statuses or that are failing to report following detection of the emergency event.

At block 556, the building-resource management system 100 can locate persons within the building 104. In response to the detection of the emergency event, the control module 102 (e.g., the emergency processing module 259) can access the location history 222 of FIG. 2 and/or the last-known occupant locations to locate all user devices 152 in the building 104. In some embodiments, in response to detecting the emergency event, the emergency processing module 259 can trigger the occupant management module 202 and/or the occupant location manager 206, which can update or recalculate the current location 220 of all or a portion of registered user devices 152 using one or more processes described above. The emergency processing module 259 can use the locations of the user devices 152 as a representation of locations of the people/occupants in the building.

At block 558, the building-resource management system 100 can calculate a route set that includes the personal emergency route 268 of FIG. 2 for each of the persons/occupants in the building 104. In response to the detection of the emergency event, the emergency processing module 259 can trigger the routing module 256 to calculate the route set. Accordingly, the routing module 256 can calculate the personal emergency routes 268 using one or more additional conditions associated with the emergency event. For example, the routing module 256 can calculate the personal emergency routes 268 to avoid the locations affected by the emergency (i.e., processing results from block 554), such as by increasing one or more weights at map edges and/or nodes including and/or within a threshold distance from the affected locations.

In some embodiments, for emergency evacuations, the routing module 256 can calculate the route set based on a crowd-routing mechanism 572 that accounts for behaviors/movements of groups in determining the route for all occupants. The crowd-routing mechanism 572, in some embodiments, can include a solution engine and/or a routing mechanism configured to calculate and evaluate multiple candidate routes for each occupant and/or the group of occupants. The crowd-routing mechanism 572 can include a process, an equation or a formula, a function, etc. configured to adjust map weights (e.g., path weights that represent average or typical travel speeds) according to detected conditions. As an illustrative example, the crowd-routing mechanism 572 can estimate or adjust path weights according to a density of occupants for a given area within a threshold distance from the corresponding paths. The routing module 256 can estimate the density based on determining a number of people in a segment or a predefined unit area and/or a number of people that are within a threshold distance from each other. The routing module 256 can adjust the segment/node/exit weights according to (e.g., using the predetermined formula/equation) the estimated density.

Using the updated flow rates (e.g., the segment/node/exit weights), the routing module 256 can calculate the personal emergency route 268 for each person/occupant. In some embodiments, the routing module 256 can calculate the personal emergency route 268 that accounts for and/or optimizes the evacuation of all persons in the building 104. For example, at block 574, the routing module 256 can determine an evacuation priority for one or more of the occupants. The routing module 256 can determine the evacuation priority as a rating for occupant mobility (e.g., due to an injury or other physiological conditions) based on profile information submitted by the occupant, facilities (e.g. a desk suitable for occupants utilizing wheelchairs) requested by the occupant, and/or average speeds of the occupants as recorded in their location history 222. In some embodiments, the routing module 256 can determine the evacuation priority as a representation of the proximity of the occupant to the locations affected by the emergency event. The routing module 256 can compare the mobility rating and/or separation distances (between occupant locations and the affected locations) according to one or more predetermined thresholds. The routing module 256 can calculate the route set according to the determined evacuation priority, such as by adjusting one or more weights in calculating the routes in the set and/or by calculating the routes for the higher-priority occupants before the lower-priority occupants.

In some embodiments, as illustrated at block 576, the routing module 256 can calculate the route set that minimizes a sum of travel times of the persons/occupants. For example, in calculating the candidate routes, the routing module 256 can further calculate an estimated travel time for each route, such as according to corresponding weights for the path segments and/or the nodes in the route. The routing module 256 can calculate a sum of the estimated travel times for all of the combinations of the candidate routes. Using a problem solver in some embodiments, the routing module 256 evaluate multiple combinations of routes according to the sum of the estimated travel times and select the route combination with the lowest sum as the route set. In some embodiments, the routing module 256 can sequentially calculate the routes for people according to the evacuation priority. As one set of routes are calculated, the routing module 256 can further adjust the edge/node/exit/etc. weights to represent the people that will be traversing according to the previously calculated set(s) of routes. The routing module 256 can evaluate the weight adjustments as a representation of a sum of travel times for the subsequent group and calculate one or more of the prior route sets to minimize the weight adjustments.

In some embodiments, as illustrated at block 578, the routing module 256 can calculate the route set that includes routes with travel times that satisfies a predetermined evacuation time threshold associated with the emergency event. For example, the routing module 256 can calculate the estimated travel time for each candidate evacuation route as described above, and then compare them to a previously defined threshold for the evacuation time that is associated with the emergency event. The routing module 256 can discard any routes/solutions that include routes with travel times that exceed the predefined threshold.

In some embodiments, the routing module 256 can calculate comparison metrics (e.g., targets or thresholds) that can be used to estimate and evaluate a progress of occupant evacuation. In some embodiments, the comparison metrics (e.g., points along the route that correspond to elapsed travel times) can be calculated based on targeted travel speeds of individuals, groups, and/or through locations. In some embodiments, the comparison metrics can be based on a threshold for changes in map weights, such as for triggering a re-evaluation process when a path/node weight for travel speed exceeds the threshold. As described in detail below, the routing module 256 can measure a progress as the occupants evacuate the building 104 and compare the measure to the comparison metrics to evaluate changes to the route set.

At block 560, the building-resource management system 100 can provide individualized evacuation guidance to occupants in the building 104. For example, in some embodiments, the routing module 256 can send the personal emergency route 268, the navigation instructions, the comparison metrics, etc. to the corresponding user device 152 and/or the building control application 154. At block 580, the building-resource management system 100 (e.g., via the user device 152) can provide the navigation guidance in real-time to the occupants according to their personal emergency route 268 and/or the current locations 220 of their user devices 152. The building control application 154 can operate the corresponding user device 152 to communicate the personal emergency route 268 and/or the associated turn-by-turn navigation instructions to the occupant, such as by displaying the personal emergency route 268 and/or by displaying or audibly playing the navigation instructions through the occupant interface 204.

As the occupants move, the building-resource management system 100 (e.g., the occupant location manager 206) can track the current locations 220 of the user devices 152 of the occupants as illustrated at block 582. The occupant location manager 206 can track the current locations 220 using one or more processes described above. In some embodiments, as illustrated at block 584, the building-resource management system 100 (e.g., the occupant location manager 206 and/or the emergency processing module 259) can communicate, substantially in real-time and according to a predetermined process/protocol, the current locations 220 a device associated with an emergency service (e.g., the fire department, the police, etc.).

At decision block 562, the building-resource management system 100 can determine whether an update interrupt has occurred. For example, the routing module 256 and/or the emergency processing module 259 can include a timer function that is configured to initiate periodic re-evaluation of the evacuation process. Also, the routing module 256 and/or the emergency processing module 259 can periodically/continuously check and update the list of locations affected by the emergency event, such as for tracking the fire or movements of an active shooter. When the list of locations change (e.g., by more than a predetermined threshold), the routing module 256 and/or the emergency processing module 259 generate the interrupt event. The building-resource management system 100 can continue to provide the real-time navigation/guidance until the interrupt event occurs.

At block 564, when the interrupt event occurs, the building-resource management system 100 can calculate a remaining travel time for the evacuation routes in the route set. The routing module 256 can track a progress of one or more persons in the building by calculating a remaining evacuation time for the one or more persons according to their evacuation routes and their current locations 220. The routing module 256 can calculate the remaining evacuation time based on the updated weights for the portions of the evacuation routes ahead of the current location 220.

At decision block 566, the building-resource management system 100 can determine whether the current evacuation status (e.g., the remaining time and/or the current locations 220) deviates from a targeted pace. For example, the routing module 256 can evaluate the progress relative to the targeted pace by comparing the current location 220, the current time, the remaining evacuation time, or a combination thereof for the one or more occupants against the above-described comparison metrics that correspond to their routes. Also, the routing module 256 can compare remaining portions of the current routes to the updated set of affected locations.

When the comparison shows that the occupants are on pace (e.g., the evacuation progress of the occupants meet or exceed the comparison metrics) and/or the remaining routes are away from the affected locations by at least a threshold distance, as represented by a loop-back path to block 560, the building-resource management system 100 can continue to provide navigation guidance for the occupants using the same route set. When the comparison shows that the occupants are off pace (e.g., the evacuation progress failing to meet the comparison metrics) and/or when the current routes overlap or are within a predetermined threshold distance from any of the affected locations, as represented by a loop-back path to block 558, the building-resource management system 100 can calculate one or more replacement routes from the current location 220 for one or more persons in the building 104. Accordingly, the building-resource management system 100 (e.g., the routing module 256) can recalculate paths from the current locations using one or more processes described above.

At decision block 592, the building-resource management system 100 can determine whether the new routes provide sufficient improvements over the initial evacuation routes. The routing module 256 can compare travel times for the new routes to the remaining travel times of the previous routes. The routing module 256 can further compare the two travel times according to a hysteresis parameter (e.g., a predetermined factor, ratio, etc.) configured to prevent rapid changes in the routes.

When the travel times of the newly calculated routs are not insufficiently (e.g., falling below the hysteresis parameter) lower than the remaining travel times of the current routes, such as represented by the flow to block 560, the building-resource management system 100 can continue using the initially presented routes to guide the occupants. When the new travel times are sufficiently shorter (e.g., exceeding the hysteresis parameters), such as illustrated at block 594, the routing module 256 can select the new routes to replace one or more of the previously presented routes in the route set. Accordingly, at block 560, the building-resource management system 100 can communicate the new routes to the user devices when the progress falls below a threshold (e.g., the comparison metrics and/or the hysteresis parameter), notify the occupants of the change, and begin guiding the occupants using the new routes.

The personal emergency route 268 communicated through the user device in the event of emergencies provides increased safety for building occupants. New or temporary occupants may not be aware of the exit locations of the building or the emergency protocols. As such, communicating the personal emergency route 268 can increase the likelihood that the occupant will find the exit and evacuate the building. Further, by calculating the route set that accounts for group behaviors, the building-resource management system 100 reduces the overall evacuation time for all occupants. Based on locating all assigned occupants, the building-resource management system 100 can determine crowds and their density. Since all occupants will be moving simultaneously during an evacuation event, the building-resource management system 100 can account for the effect of the crowd on the mobility of the building occupants. Accordingly, the building-resource management system 100 can reduce the overall evacuation time for the occupants by processing the occupants as a group rather than separately/individually.

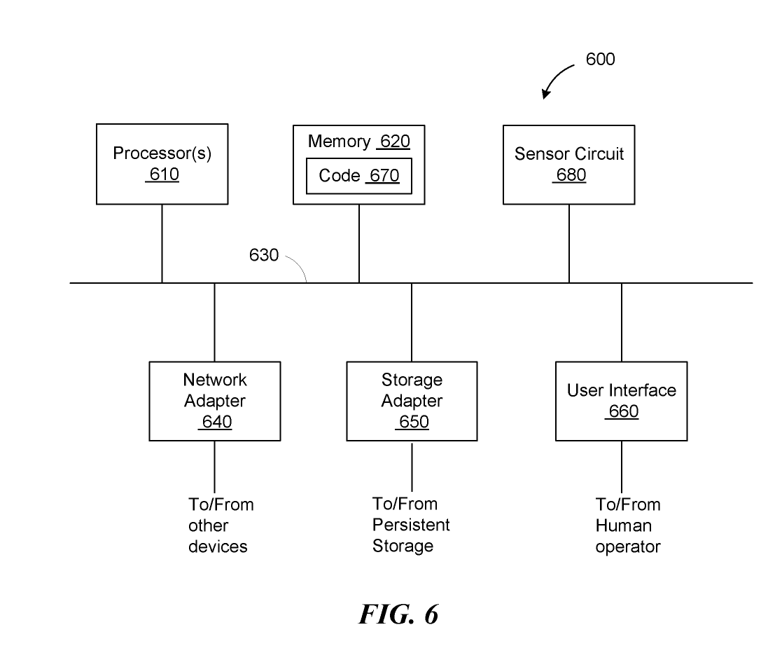

FIG. 6 is a block diagram of an example computing device 600 in accordance with various embodiments. The computing device 600 can include one or more computing devices (e.g., devices illustrated in FIG. 1, such as the system managing devices 112, the building subsystems or portions thereof, the linking devices 136, the communication nodes 138, the sensors 140, including the presence sensors 142, the user devices 152, etc.) that implement at least a portion of the process 500 of FIG. 5. The computing device 600 includes one or more processors 610 and memory 620 connected to an interconnect 630. The interconnect 630 is an abstraction that represents any one or more separate physical buses, point-to-point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”. The interconnect 630 can also include wireless connection or communications between components.

The processor(s) 610 is/are the central processing unit (CPU) of the computing device 600 and thus controls the overall operation of the computing device 600. In certain embodiments, the processor(s) 610 accomplishes this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 620 is or includes the main memory of the computing device 600. The memory 620 represents any form of random access memory (RAM), read-only memory (ROM), flash memory, or the like, or a combination of such devices. In use, the memory 620 may contain a code 670 (e.g., applications, device-specific executables, etc.) containing instructions according to the operation of at least a portion of the process 500 disclosed herein. The code 670 stored in memory 620 may be implemented as software and/or firmware to program the processor(s) 610 to carry out actions described above. In certain embodiments, such software or firmware may be initially provided to the computing device 600 by downloading it from a remote system through the computing device 600 (e.g., via network adapter 640).

Also connected to the processor(s) 610 through the interconnect 630 may be a network adapter 640 and/or a storage adapter 650. The network adapter 640 provides the computing device 600 with the ability to communicate with remote devices, over a network and may be, for example, an Ethernet adapter, Fibre Channel adapter, or a wireless modem. The network adapter 640 may also provide one or more devices in the building 104 of FIG. 1 with the ability to communicate with other computers. The storage adapter 650 enables the computing device 600 to access a persistent storage, and may be, for example, a Fibre Channel adapter or SCSI adapter.

The computing device 600 can further include one or more user interfaces 660 connected to the interconnect 630. The user interfaces 660 can communicate information to a user and/or receive inputs/information from the user. For example, the user interfaces 660 can include a display screen, a speaker, a haptic device, etc. Also, the user interfaces 660 can include a touch screen, a keyboard, a mouse, a microphone, etc. Also, the user interfaces 660 can include one or more GUIs.

In some embodiments, the computing device 600 can include a sensor circuit 680 connected to the interconnect 630. The sensor circuit 680 can measure one or more aspects of the surrounding environment. For example, the sensor circuit 680 can include various sensors discussed above, such as one or more circuits configured to measure/detect thermal energy/temperature, waves (e.g., light, sound, etc.), particles and/or gases, acceleration, magnetic field, device orientation, or a combination thereof.

Overall, the system/process described herein may be implemented for execution by any suitable computing environment in which the invention can be implemented. The system may be implemented by routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a network. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

It is understood that the above described embodiments can be implemented using one or more devices (e.g., processors, Field Programmable Gate Arrays (FPGAs), state machines, memory devices, such as volatile or non-volatile memory, communication devices, such as modems or transceivers, user or device interfaces, or a combination thereof). Further, the discussed embodiments can be implemented in a networked environment. For example, the system can interact with the consumer through a user device (e.g., a personal computer or a laptop computer, a mobile device, etc.), which can be connected to one or more service provider devices (e.g., servers) implementing or executing one or more processes discussed above. The service provider devices can include lender devices or be separately connected to the lender devices (e.g., servers belonging to or operated by the lenders). The various devices can be connected using a communication network (e.g., telephone network, a local area network (LAN), a wide area network (WAN), a cellular network, etc.).

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method of operating a system for assigning at least one occupant space in a building to an occupant, the method comprising:
receiving a reservation request from a user device to reserve the occupant space for the occupant;
assigning the occupant space for use by the occupant; and
calculating a personal route based on the occupant space, wherein the personal route is for guiding the occupant within the building to or from the occupant space.

2. The method of claim 1, wherein the occupant space comprises a rental space, a workshare space, a coworking space, or a shared workspace.

3. The method of claim 1, further comprising:
determining the current location of the user device associated with the occupant;
determining an occupancy duration associated with the occupant space based on tracking the current location over time; and
calculating a cost associated with use of the occupant space based on the occupancy duration.

4. The method of claim 1, wherein:
the reservation request is for reserving one of available conference rooms;
further comprising:
calculating comparison routes to travel to the available conference rooms for the occupant;
determining meeting participants associated with the reservation request;
calculating participant routes to the available conference rooms for the meeting participants; and
selecting one of the available conference rooms as the assigned space based on the comparison routes and the participant routes for each of the available conference rooms.

5. The method of claim 4, further comprising:
calculating a travel distance sum for each of the available conference rooms based on combining travel distances of the one of the comparison routes and the participant routes thereto, wherein selecting the one of the available conference rooms includes selecting the one of the available conference rooms that corresponds to a lowest instance of the travel distance sum.

6. The method of claim 4, further comprising:
calculating a travel time sum for each of the available conference rooms based on combining travel times of the one of the comparison route and the participant routes thereto, wherein selecting the one of the available conference rooms includes selecting the one of the available conference rooms that corresponds to a lowest instance of the travel time sum.

7. The method of claim 4, further comprising:
determining a maximum travel time for each of the available conference rooms based on travel times of the one of the comparison route and the participant routes thereto, wherein selecting the one of the available conference rooms includes selecting the one of the available conference rooms that corresponds to a lowest instance of the maximum travel time.

8. The method of claim 1, further comprising:
calculating a resource usage history of the occupant space based on tracking a current location of the user device within the building, wherein the resource usage history represents usage or consumption by the occupant of one or more facilities, utilities, services, resources, or a combination thereof at the building;
predicting an upcoming demand for the occupant space based on the resource usage history; and
calculating a usage price for the occupant space based on the upcoming demand.

9. The method of claim 1, further comprising:
determining a preference of the occupant based on the reservation request, wherein the preference is for a shared or rental equipment available for the occupant space;
determining a current location representing the occupant; and
assigning the shared or rental equipment along with the occupant space.

10. The method of claim 1, further comprising:
detecting an emergency event;
determining a location in the building associated with the emergency event;
locating assigned occupants in the building in response to the emergency event; and
calculating a route set, wherein the route set includes an evacuation route for each of the assigned occupants.

11. The method of claim 10, wherein calculating the route set includes calculating the route set that minimizes a sum of travel times associated with routes in the route set.

12. The method of claim 10, wherein calculating the route set includes calculating routes with travel times that satisfies an evacuation time threshold associated with the emergency event.

13. The method of claim 10, further comprising communicating the evacuation route to a user device associated with the occupant for providing a real-time turn-by-turn navigation to the occupant.

14. The method of claim 13, further comprising:
tracking the current locations that represent the assigned occupants traversing the corresponding evacuation routes;
calculating a remaining evacuation time for each of the assigned occupants;
according to a predetermined interval, tracking a progress of the assigned occupants;
calculating a replacement route from a current location for each of the assigned occupants when the progress falls below a threshold; and
communicating the replacement route to the user device when the progress falls below a threshold.

15. The method of claim 14, wherein:
calculating the route set includes calculating comparison metrics for estimating the progress of evacuation; and
tracking the progress includes comparing the current location, a current time, or a combination thereof for one or more of the assigned occupants to the comparison metrics.

16. The method of claim 14, further comprising selecting the replacement route to replace one or more routes in the route set when the replacement route reduces an estimated travel time by more than a hysteresis parameter.

17. The method of claim 10, wherein calculating the route set includes calculating the route set based on a crowd routing mechanism that estimates a flow rate based on a density of occupants for a given area.

18. The method of claim 10, further comprising communicating real-time locations of the occupants to a device associated with an emergency service.

19. A tangible, non-transient computer-readable medium having processor instructions encoded thereon that, when executed by one or more processors, configures the one or more processors to perform a method of assigning at least one occupant space in a building to an occupant, the instructions comprising:
receiving a reservation request from a user device to reserve the occupant space for the occupant;
assigning the occupant space for use by the occupant; and
calculating a personal route based on the occupant space, wherein the personal route is for guiding the occupant within the building to or from the occupant space.

20. A system for assigning least one occupant space in a building, the system comprising:
at least one computer-based processor; and
at least one computer-based memory connected to the computer-based processor and having stored thereon instructions executable by the computer-based processor to cause the computer-based processor to:
receive a reservation request from a user device to reserve the occupant space for the occupant;
assign the occupant space for use by the occupant; and
calculate a personal route based on the occupant space, wherein the personal route is for guiding the occupant within the building to or from the occupant space.
